(19) United States
(12) Patent Application Publication
(10) Pub. No.: US 2009/0241610 A1
(43) Pub. Date: Oct. 1, 2009

(54) STRUCTURES AND WINGS

(75) Inventors: John Russell Watts, Albert Park (AU); David Greenbury, Victoria (AU); Brendan George, Victoria (AU)

Correspondence Address: SUGHRUE MION, PLLC, 2100 PENNSYLVANIA AVENUE, N.W., SUITE 800, WASHINGTON, DC, 20037, US

(73) Assignee: JORGENSON-WATTS PTY LTD, Melbourne (AU)

(21) Appl. No.: 12/303,329

(22) PCT Filed: Jun. 14, 2007
(86) PCT No.: PCT/AU2007/000865

§ 371 Date: Dec. 3, 2008

Related U.S. Application Data
(60) Provisional application No. 60/816,329, filed on Jun. 26, 2006.
(60) Provisional application No. 60/832,947, filed on Jul. 25, 2006.

(30) Foreign Application Priority Data
Oct. 24, 2006 (AU) 2006905923
Dec. 15, 2006 (AU) 2006907010
Mar. 20, 2007 (AU) 2007901447
May 7, 2007 (AU) 2007902391

(51) Int. Cl. E06B 1/04; E05B 65/00

(52) U.S. Cl. 70/91; 52/217; 49/505

(57) ABSTRACT

A wing including an infill of fixed extent and an outer frame including at least two outer frame member comprises at least one of which includes a pair of associated outer frame portions connected by a telescopic joint comprising a linear joint, said outer frame members connected at a corner joint defined in part by an included angle that may be changed, said the infill bounded by an inner frame having an outwardly disposed peripheral channel supported in relation to the outer frame that at least in part occupies the channel.

### BACKGROUND AND UNRESOLVED NEEDS

The inventions within address, amongst other issues, an age-old problem with doors and in particular with security and storm doors; that of fitting a pre-made door to an opening so that it occupies the opening with acceptable working clearances so as to be neither too large and unable to fit within the opening nor too small and having unacceptable “gaps” left around the periphery of the door. The inventions similarly address an age-old problem with screens and in particular with window screens; that of fitting a pre-made screen to a window opening so that it occupies the opening with acceptable clearances.

Some openings are fabricated according to standard dimensions, some are constructed on site of convenient dimensions, some through poor workmanship are non-rectangular and some openings become skewed as a result of house settlement. In spite of this, some DIY retailers sell doors of standard sizes to suit the openings described above often resulting in a poorly fitting door. In other cases, doors are “made-to-measure”; a process where the opening is measured and a door manufactured to suit the particular opening—sometimes even this process results in a poorly fitting door.

One objective of the inventions described herein, is to provide a door that is adjustable to suit openings of different widths and/or different heights and a particular objective is to provide a screen door that suits the different common door openings in a particular countries/territory and a more particular objective is to provide a door that suits the different common openings in Australia which range in width from 806 to 818 MM and in height from 2024 to 2042 MM and a more particular invention embraces the ranges of (800 to 830)×(2010 to 250) MM requiring 30 MM and 40 MM adjustment respectively. Such a door would be manufactured without reference to particular openings (which is time consuming and expensive) and by modern manufacturing techniques and systems resulting in reduced manufacturing costs an improved quality. A further objective is to manufacture the door without any or with minimal welding. Yet another objective is to provide a door that can be configured to fit within a normal sedan vehicle so that it can easily be transported home to be assembled and fitted by a handyman—this type of door overcoming a difficulty experienced by shoppers who purchase doors from retail outlets.

Although the inventions within were prompted by a need for an improved door, they are also relevant to structures in general including other forms of wings.

### SUMMARY OF THE INVENTIONS

According to one aspect of the invention, there is a structure including an infill overlapping an outer frame configurable to define the extent of the structure.

In a second aspect of the invention, the outer frame includes at least one outer frame member defined in part by a length that may be changed.

In a third aspect of the invention, the at least one outer frame member comprises a pair of associated outer frame portions connected by a telescopic joint comprising a linear joint.

In a fourth aspect of the invention, each outer frame member comprises a pair of associated outer frame portions connected by a telescopic joint comprising a linear joint.

In a fifth aspect of the invention, at least one outer frame member adjusts in length in response to rotation of a threaded fastener.

In a sixth aspect of the invention, the outer frame member includes at least two outer frame members connected at a corner joint defined in part by an included angle that may be changed.

In a seventh aspect of the invention, there is the means by which to urge the infill towards the centre of area of the outer frame.

In an eighth aspect of the invention, there is the opposed identical springs the length of which is changed in response to configuring of the outer frame.

In a ninth aspect of the invention, the infill supported in relation to the outer frame is adaptable.

In a tenth aspect of the invention, the infill comprises strips of fixed length connected by a telescopic joint.

In an eleventh aspect of the invention, there is an outer frame comprising two pair of opposed outer frame members, each said outer frame member including a pair of associated outer frame portions connected by a linear joint, each said outer frame member being connected to each outer frame member of the other pair by a corner joint each of which is defined in part by an included angle that may be changed.

In a twelfth aspect of the invention, the infill supported in relation to the outer frame is of fixed extent.

In a thirteenth aspect of the invention, the infill is bounded by an inner frame having an outwardly disposed peripheral channel supported in relation to the outer frame that at least in part occupies the channel.

In fourteenth aspect of the invention, the inner frame is rectangular.

In a fifteenth aspect of the invention, the outer frame comprises two pair of opposed outer frame members, each said outer frame member including a pair of associated outer frame portions connected by a linear joint, each said outer frame member being connected to each outer frame member of the other pair by a corner joint defined in part by an included angle that may be changed.

In a sixteenth aspect of the invention, the corner joint comprises an adaptable mortise joint.

In a seventeenth aspect of the invention, the corner joint comprises an adaptable butt joint.

In an eighteenth aspect of the invention, the butt joint is configured as an enhanced butt joint.

In a nineteenth aspect of the invention, the butt joint is configured as an articulated butt joint.

In a twentieth aspect of the invention, the linear joint is configured as a type 1 linear joint.

In a twenty-first aspect of the invention, the linear joint is configured as a type 2 linear joint.

In a twenty-second aspect of the invention, the linear joint is configured as a type 3 linear joint.

In a twenty-third aspect of the invention, the linear joint is configured as a type 4 linear joint.

In a twenty-fourth aspect of the invention, means by which to urge the infill towards the centre of area of the outer frame includes a type 1 orthogonal joint.

In a twenty-fifth aspect of the invention, means by which to urge the infill towards the centre of area of the outer frame includes a type 2 orthogonal joint.

In a twenty-sixth aspect of the invention, means by which to urge the infill towards the centre of area of the outer frame includes a type 3 orthogonal joint.

In a twenty-seventh aspect of the invention, the infill includes multiple sub-infills.

In a twenty-eighth aspect of the invention, there is a structure characterized by having a Type 3 linear joints and a Type 2 orthogonal joint disposed towards the middle of the outer frame members belonging to the first pair and a Type 4 linear joint within the outer frame members of the second pair and Type 3 orthogonal joints disposed towards each ends of each outer frame member within the second pair.

In a twenty-ninth aspect of the invention, there is a structure configured as a structure.

In a thirtieth aspect of the invention, there is a structure configured as a fixable shutter.

In a thirty-first aspect of the invention, there is a structure configured as an angularly displaceable door and having a lock attached to a closing edge of the structure.

In a thirty-second aspect of the invention, there is a structure configured as an angularly displaceable screen door and having a lock attached to a closing edge of the door.

In a thirty-third aspect of the invention, there is a structure configured as a sliding door supported on rollers and having a lock attached to a closing edge of the structure.

According to another aspect of the invention, there is a structure substantially as described herein with reference to and as illustrated in the accompanying drawings.

The elements relating to the various aspects of the invention claimed within are identified within the specification as follows; where unless the context requires otherwise,
“Locks” or variations such as “lock” will be understood to include complete locks for wings and improvements in locks for wings that are transportable into other locks and locking devices without being limited to the complete locks described herein.
“Comprise” or variations such as “comprises” or “comprising” will be understood to imply the inclusion of a stated integer or group of integers but not the exclusion of any other integer or group of integers.
Positional prepositions such as “rear” and “forward” are used to assist in description of the preferred embodiments and with reference to the accompanying drawings and have in general, no absolute significance
“Overlap” and derivations such as “overlaps” implies at least in-part, occupying a same plane as.
“Extent” will be understood to embrace area, form and shape.
Headings are included for convenience only and not to affect on interpretation.
“Preferably” or variations such as “prefer” does not imply that the form of an integer is restricted to that referred to as preferred, but implies acceptable and if need be, able to adequately perform a function required by the inventions in which it is included,
“Wing” or variations such as “wings” will be understood to imply a form of structure that includes: a complete wing and improvements in wings that are transportable into other structures, wings or devices without being limited to the applications described herein; wings embraces in particular “doors”, “windows”, “shutters”, “screens”.
“Member” is an identifiable entity having material form that may include one or more identifiable components.
“Material” includes elements, alloys, plastics and other substances.
“Aperture” and “recess” embrace a hole that extends from a surface while
“Aperture” in some contexts implies a hole that extends between surfaces.
“Furniture” includes door furniture that includes a “Handle Assembly” that includes a handle supported by a base that together in one form comprise an unlatching lever supported by a back-plate; “Handle” includes a knob, lever and an unlatching lever; “Unlatching Lever” includes a lever or knob that is hand operable to cause an engaging member to become unlatched”; “Base” includes a rose that may include a surface mounted member having a recess on the underside; “Back-Plate” (or “back-plate”) includes a surface mounted box-like member having a recess on the underside.
“Engaging Member” in isolated use, is a member displaceable between a fully displaced disposition and a fully retracted disposition. When employed with an “Engageable Member”, the engaging member is displaceable between an operative disposition (in which the engaging member finds itself when engaged with the engageable member) and an inoperative disposition removed from the said engagement. Within this specification, fully displaced will embrace the operative disposition and retracted disposition will embrace the inoperative disposition.
“Latching” implies displacement of an “engaging member” into engagement with an “engageable member” under the action of biasing means,
“Latch-Bolt” or “latch bolt” is an outwardly biased bolt capable of executing (or participating in) latching and includes bolts having a leading end that is chamfered or otherwise profiled on one or both sides.
“Auxiliary bolt” is a plunger that is operably associated with a latch bolt.
“Unlatching” means withdrawal of the engaging member from engagement.
“Locking” means the act of configuring the lock to restrain it from being unlatched and in some forms of locks employing deadlocking slides, it means restraining the deadlocking slide to restrain the bolt from being inwardly displaced in response to operation of the unlatching lever.
“French Door” means a door including a frame and a glass in-fill
“Screen door” means a door including a frame and an insect restraining in-fill such as fiberglass mesh, woven mesh or perforated metal mesh;
“Lock Body” includes an engaging member and a lock casing and an Australian conventional security door lock is able to fit within an industry-standard door preparation and has a lock casing having dimensions substantially; Depth 35 to 45 MM, Width 14.5 to 16 MM and Length 147 MM
“Mortise Lock” means a lock including a lock body, a strike plate, a pair of handle assemblies and a cylinder where the lock body is configured to be fitted within the frame of the wing.
“Single cylinder” means a substantially conventional lock cylinder comprising a separate sub-assembly that includes a key operable barrel within a cylinder housing.
“Double-Cylinder” comprises a substantially conventional double lock cylinder comprising a separate sub-assembly that includes opposed coaxially supported barrels each operably connected to the same angularly displaceable “first cam” having a “first cam arm” characterized by a “free end” that extends radially to a “peripheral surface” defined in part by a common radial distance from the first cam pivotal axis and where in a conventional double cylinder this radial distance is 15.0 MM.
A “mortise joint” includes two elongated members have ends that abut along an entire angled edge and in this configuration the angle at which the axis of the members are disposed to each other is said to be the “nominal angle”;
An “orthogonal mortise joint” has orthogonally disposed members having a nominal angle of 90 degrees and abutting ends each angled at 45 degrees,
A “pseudo mortise joint” is a mortise joint where the two elongated members are relatively disposed at an angle [“deviation”] slightly different from the nominal angle so that their ends abut at a corner only to have a wedge like gap between them an a “pseudo orthogonal mortise joint” has members having abutting ends angled at 45 degrees that abut only at a corner.
A “butt joint” is a joint characterized by two elongated hollow members relatively disposed at an included angle to each other where an end of a first member (disposed at a nominal angle to its longitudinal axis) abuts a side of a second member along the entire periphery of the end and where the included angle is equal to the nominal angle.
An “orthogonal buff joint” is a joint characterized by the two elongated hollow members being relatively disposed at an angle 90 degrees.
A “pseudo butt joint” is a joint characterized by the included angle being slightly different to the nominal angle and the first member abuts a side of a second member at a corner and a “pseudo orthogonal butt joint” is a joint characterized by two elongated hollow members being disposed at an angle different from 90 degrees by the “deviation”.
“Deviation” is an incremental angle=nominal angle−included angle
“Cross-Sectional View” in relation to figures should be interpreted as an orthogonal cross-sectional view defined by a plain orthogonal to the axis of the member in consideration.

Patent Specification shall be taken to include: a Body [comprising a Title, a Description of Preferred Embodiment/s, an Abstract and a Summary of the Invention] and Claims.

Unless the context requires otherwise, any prior publications and usage referred to herein, is not an assertion that any of this material forms part of the common general knowledge in the art in any other country at the priority date of any claim herein (or the priority date of any future claimed derived at least in part from this specification).

The integers relating to the various aspects of the invention claimed within and other elements described within may also be employed within other inventions subject of divisional applications.

The inventions described within derive, at least in part, from those described in associated provisional applications and where unless the context requires otherwise, where an integer is attributed with attributes different from those attributed in an earlier provisional application, the integer will be considered to be the same integer in a different form; where there is actual inconsistency between a provisional application and an earlier provisional application, the latter will prevail.

### DESCRIPTION OF THE FIGURES

Notwithstanding any other forms that may fall within its scope one preferred form of the invention will now be described by way of example only with reference to the accompanying drawings in which:

FIG. 1 is an isometric view of a wing that has been further configured as an angularly displaceable door having a lock attached to a closing edge and being supported adjacent to an opening defined in part by one or more frame elements,

FIG. 2 is an isometric view of a wing that has been further configured as a rectilinearly displaceable wing having a lock attached to a closing edge and supported adjacent to an opening defined in part by one or more frame elements,

FIG. 3 is an isometric view of a cross-sectional view of an inner frame and an outer frame together,

FIG. 4 is an isometric view of a cross-sectional view of an inner frame and an alternative outer frame together,

FIG. 5 is an isometric view of an inner frame that has been further configured to correspond to an outer frame (not shown) configured to receive a lock on the closing edge,

FIG. 6 is a cross-sectional view of an inner frame having sides inclined inwardly from a base,

FIG. 7 is a cross-sectional view of an inner frame having internal longitudinally elongated shoulders that include a longitudinally elongated recess supporting to support a gasket,

FIG. 8 is a side view of a corner of an inner frame,

FIG. 9 is an isometric view of the corners of overlapping inner and outer frames,

FIG. 10 is a schematic side view of an outer frame having corner joints and a linear joint within each outer frame member,

FIG. 11 is an isometric view of an outer frame member having an edge depth “D”, a side width “W” and a side-wall thickness “t” and showing the dimensions of a particular outer frame member having D=19 MM, W=25 MM, t=1 to 2 MM

FIG. 12 is a partial isometric view of a wing that includes a lock on the closing edge,

FIG. 13 is an exploded isometric view of the wing of FIG. 12

FIG. 14 is a partial isometric view of a wing including an infill,

FIG. 15 is a partial cross-sectional view of the infill of FIG. 14,

FIG. 16 is a partial cross-sectional view of the infill of FIG. 14 adapted to include enhanced attachment,

FIG. 17 is a partial cross-sectional view of an infill constructed by an alternative method,

FIG. 18 is a partial isometric view of a wing including an infill that includes bars,

FIG. 19 is a partial cross-sectional view of the wing of FIG. 18 where the cross-section is defined by a plane parallel the face of the wing and through the centre-line of the fasteners,

FIG. 20 is a partial isometric view of a wing including an infill that includes flexible mesh,

FIG. 21 is a cross-sectional view of the inner frame and flexible mesh,

FIG. 22 is a side view of a wing further configured to include multiple infills and a lock,

FIG. 23 is a partial exploded isometric view of a wing of FIG. 22,

FIG. 24 is a partial schematic cross-sectional view of the abutting portions of the infills when relatively restrained by a first method,

FIG. 25 is a partial schematic cross-sectional view of the abutting portions of the infills when relatively restrained by an alternative, second method,

FIG. 26 is an isometric view of a connector for a mortise joint,

FIG. 27 is a schematic side view of the connector of FIG. 26 acting to connect adjacent outer frame members at an included angle of 90 degrees,

FIG. 28 is a schematic side view of the connector of FIG. 26 acting to connect adjacent outer frame members at an included angle a little greater than 90 degrees,

FIG. 29 is a partly exploded isometric view of part of a butt joint,

FIG. 30 is a partial isometric view of the other part of the butt joint of FIG. 29,

FIG. 31 is a schematic side view of the butt joint of FIGS. 29 and 30, where the included angle (“alpha”) is a little less than 90 degrees,

FIG. 32 is a schematic end view of the locking key undisplaced,

FIG. 33 is a schematic end view of the locking key displaced 90 degrees,

FIG. 34 is a partly exploded isometric view of part of an alternative butt joint,

FIG. 35 is a partial isometric view of the other part of the butt joint of FIG. 34,

FIG. 36 is a plan view of the alternative butt joint of FIGS. 34 and 35

FIG. 37 is a schematic side view of the butt joint of FIG. 36, where the included angle is a little more than 90 degrees,

FIG. 38 is a schematic cross-sectional side view of a T-1 linear connector mounted within an outer frame member,

FIG. 39 is an exploded view of the T-1 linear connector of FIG. 38,

FIG. 40 is a cross sectional view through the threaded plug,

FIG. 41 is an isometric view of a tool within the threaded plug,

FIG. 42 is a side view of an outer frame member that includes a T-2 linear joint,

FIG. 43 is an isometric view of the formed end of an outer frame portion of FIG. 42,

FIG. 44 is the cross-sectional view AA of the T-2 linear joint of FIG. 42,

FIG. 45 is a schematic view showing how the side and edge channels of the T-2 linear joint of FIG. 42, are formed,

FIG. 46 is a schematic side view of an outer frame member that includes T-3 linear joint when the outer frame member is at its maximum extent,

FIG. 47 is a schematic side view of the outer frame member of FIG. 46 at its minimum extent,

FIG. 48 is an isometric view of a portion of the T-3 linear joint,

FIG. 49 is a schematic side view of an outer frame member that includes T-4 linear joint when the outer frame member is at its maximum extent,

FIG. 50 is a schematic side view of the outer frame member of FIG. 49 at its minimum extent,

FIG. 51 is an exploded isometric view of the T-4 linear joint,

FIG. 52 is a cross sectional view through a T-1 orthogonal joint interconnecting an inner and outer frames together when the outer frame is at its minimum extent,

FIG. 53 is a cross sectional view through a T-1 orthogonal joint interconnecting an inner and outer frames together when the outer frame is at its maximum extent,

FIG. 54 is a cross sectional view through a T-2 orthogonal joint interconnecting an inner and outer frames together when the outer frame is at its minimum extent,

FIG. 55 is a cross sectional view through a T-2 orthogonal joint interconnecting an inner and outer frames together when the outer frame is at its maximum extent,

FIG. 56 is a cross sectional view through a T-3 orthogonal joint interconnecting an inner and outer frames together when the outer frame is at its minimum extent,

FIG. 57 is a cross sectional view through a T-3 orthogonal joint interconnecting an inner and outer frames together when the outer frame is at its maximum extent,

FIG. 58 is an isometric view of a wing having: in the middle of the upper and lower outer frame members a T-3 linear and an adjacent T-2 orthogonal joint; in the left hand and right hand outer frame members, a T-4 linear joint and T-3 orthogonal joints towards the upper and lower ends of these side members with the connectors displaced sideways from the wing to better illustrate their type and location.

FIG. 59 is a partial isometric view of a wing including bars and without an inner frame,

FIG. 60 is a partial isometric view of an alternative wing including bars and without an inner frame.

### DETAILED DESCRIPTION OF EMBODIMENTS CONSISTENT WITH CONCEPTS OF THE INVENTIONS

The inventions within are generally described in relation to a wing (to which they are particularly relevant) but they are also relevant to other structures (a wing being regarded as a form of structure); the material described in relation to the outer frame (including the description of the corner joints, linear joints, orthogonal joints, the methods of manufacture and adjustment and the outer frame members themselves) are all relevant to structures in general. Further, the inventions within include: a) a structure that includes one or more members taking the form of an outer frame member described within whether associated with, or not associated with an infill, and b) a structure that includes one or more members taking the form of an inner frame member described within whether associated with, or not associated with, an outer frame.

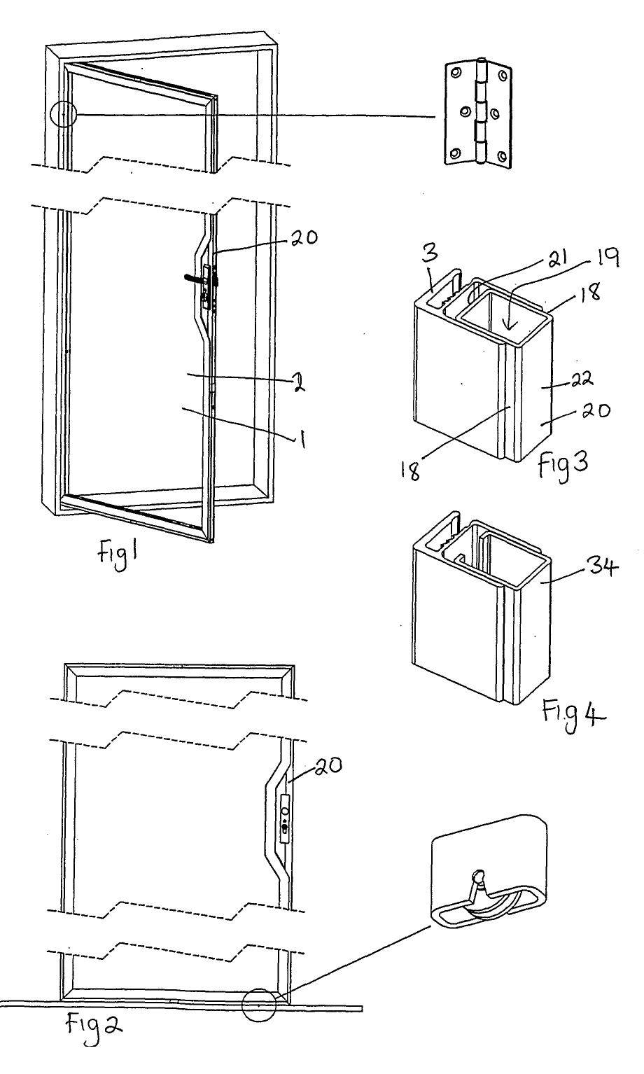

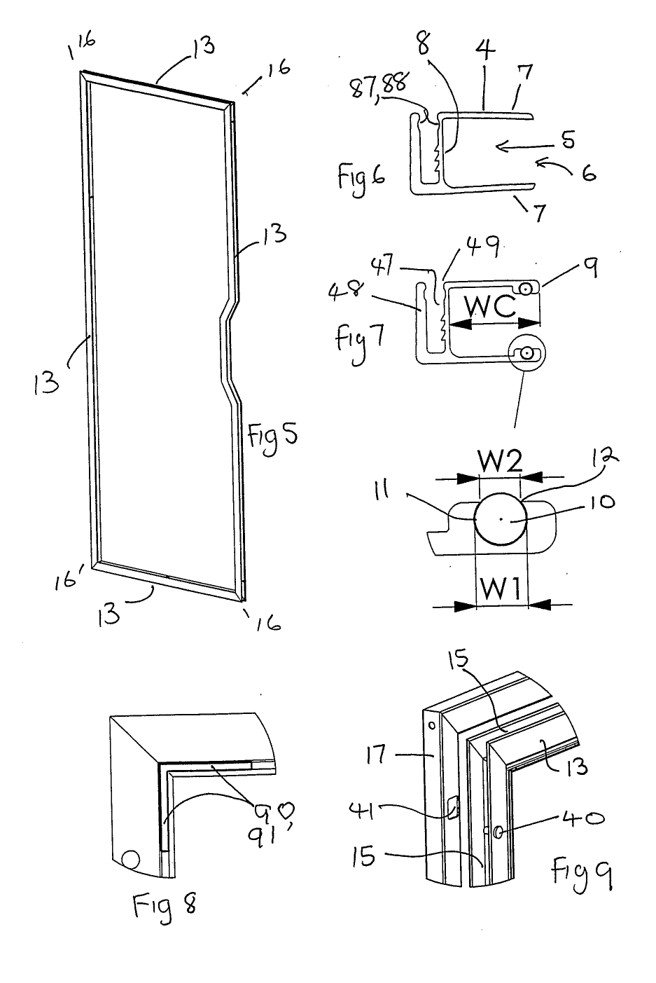

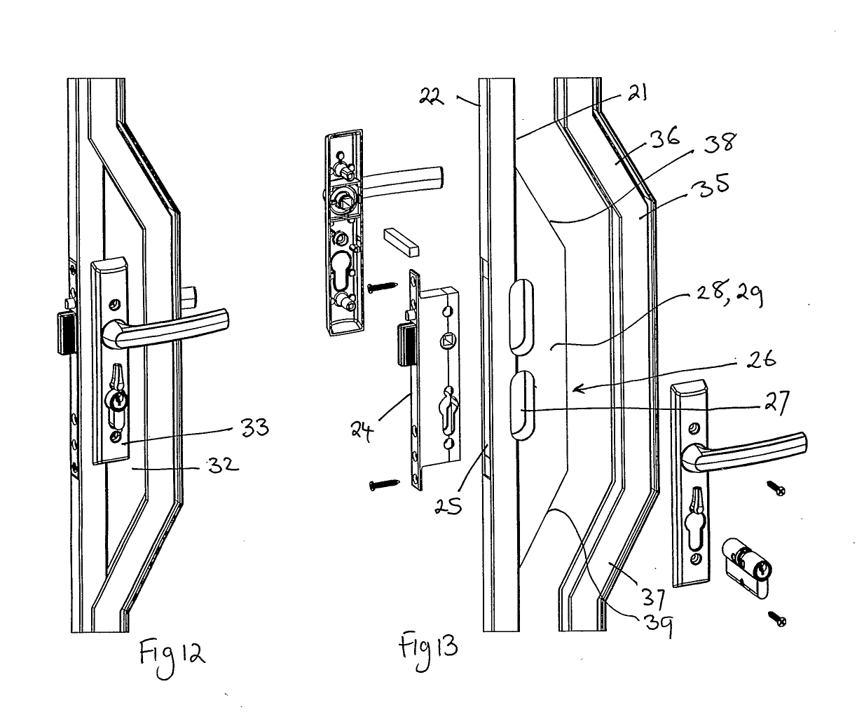

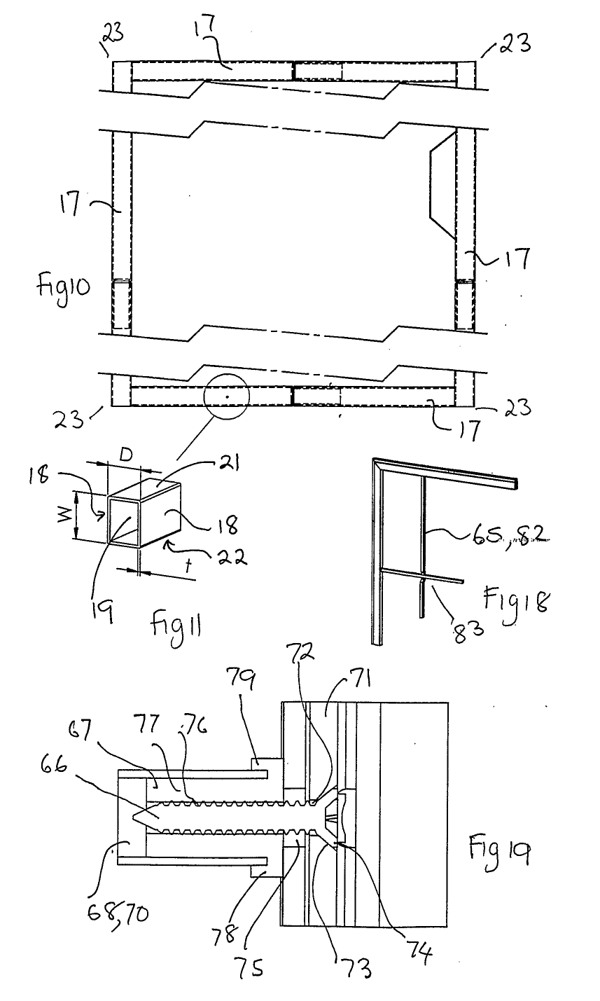

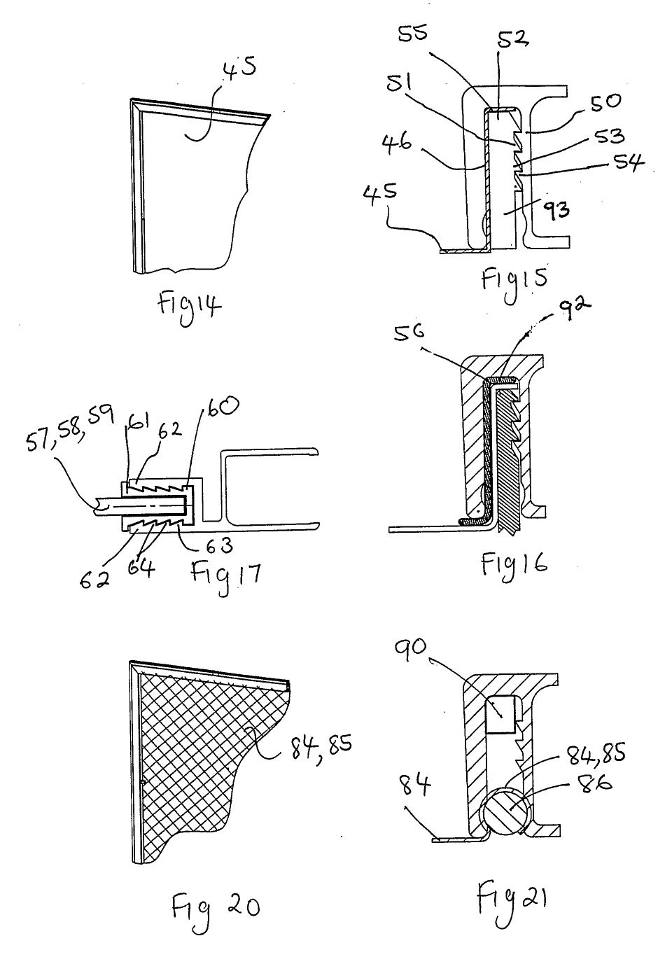

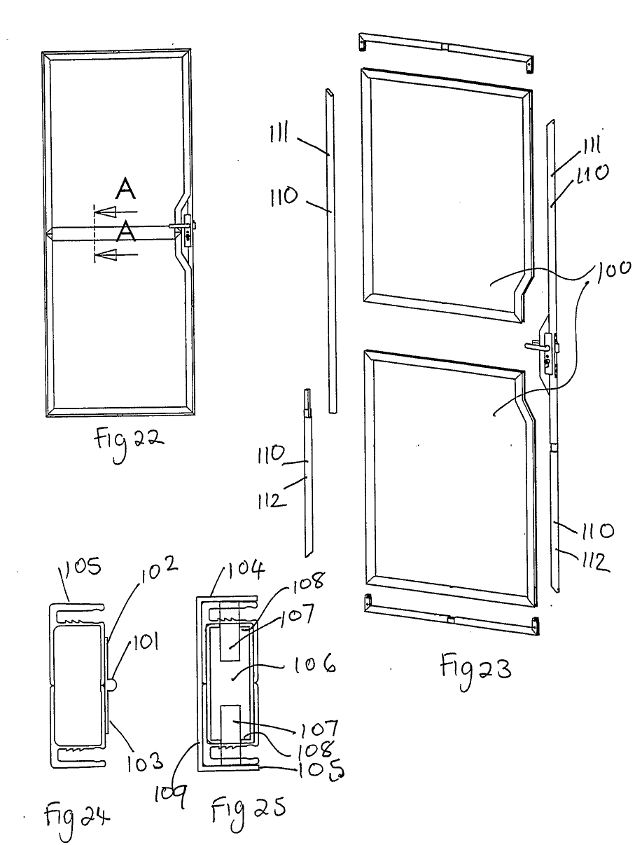

The inventions within include a wing 1 having an infill 2 (FIG. 1 to 8 and 14 to 21) (that may include glass sheet, woven steel mesh, fiberglass mesh or bars) that in some forms is bounded by a return 4 that extends along the periphery of the infill (in one form as a continuous portion, in another form as discrete interrupted portions) to extend outwardly to overlap an outer frame 20; some infills being further configured to include a pair of spaced returns 4 configured as substantially parallel sides 7 between which a substantially U shaped elongated U channel 5 extends to extend along the periphery of the infill, the channel 5 extending inwardly from an opening 6 disposed away from the infill.

In some forms, the infill includes an elongated inner frame 3 that extends along the periphery of the infill, this inner frame being configured to include a base 8 from which the sides 7 extend outwardly (and to which the sides are connected) to overlap the outer frame 20; and in some forms, this inner frame 3 extends along the entire periphery of the infill 2.

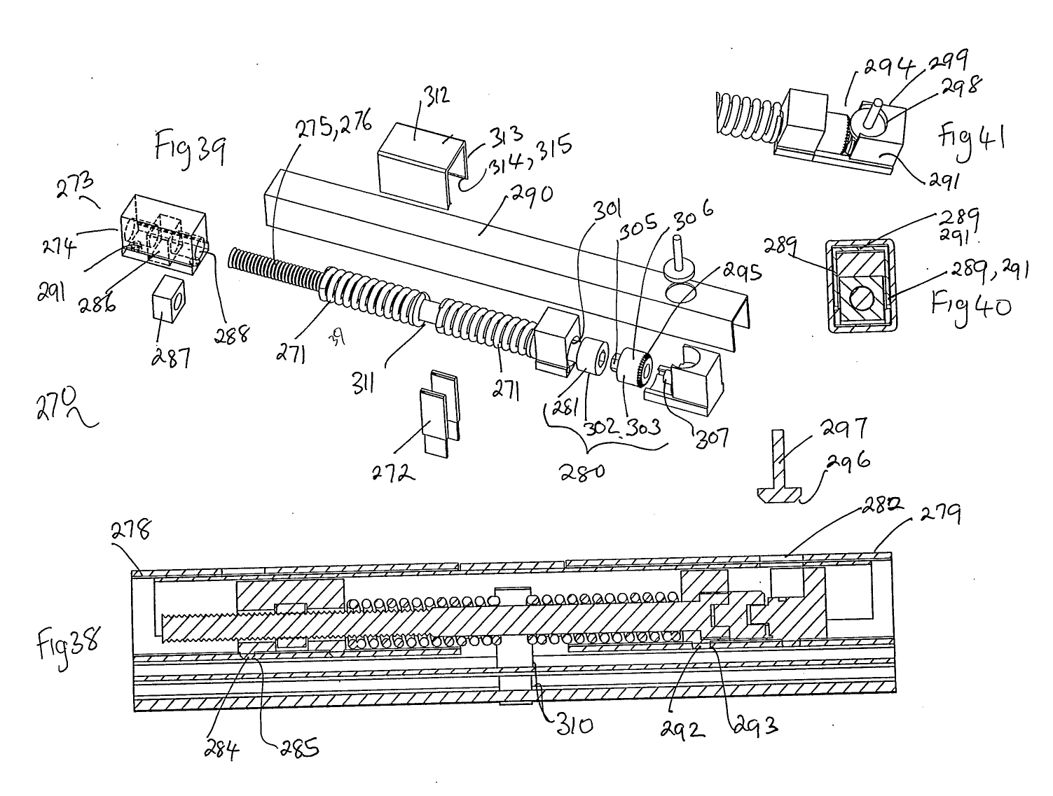

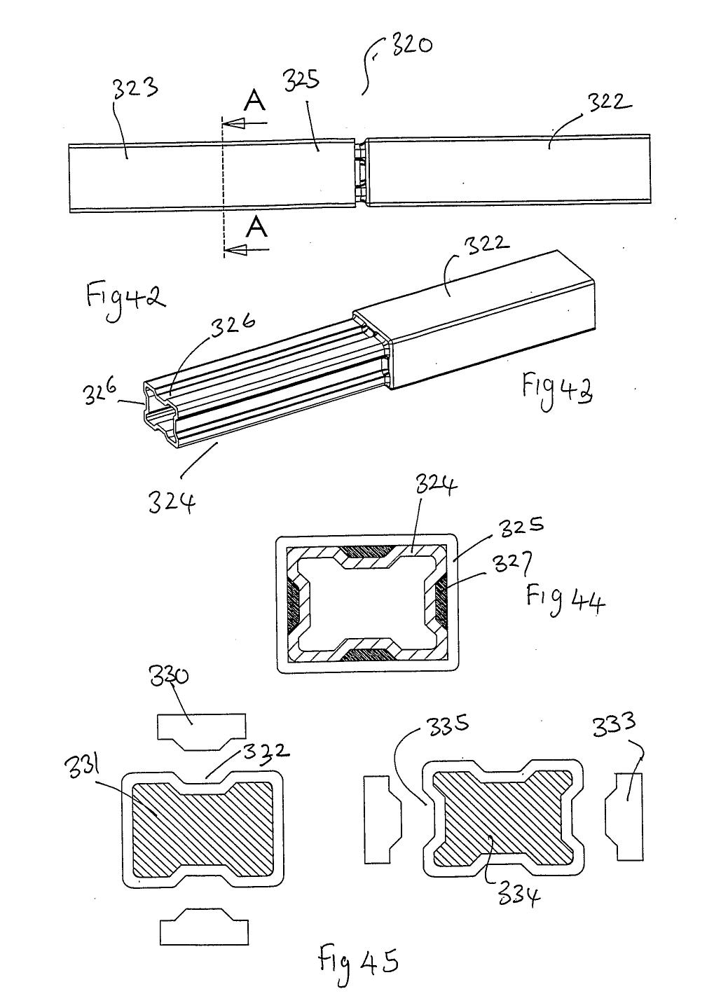

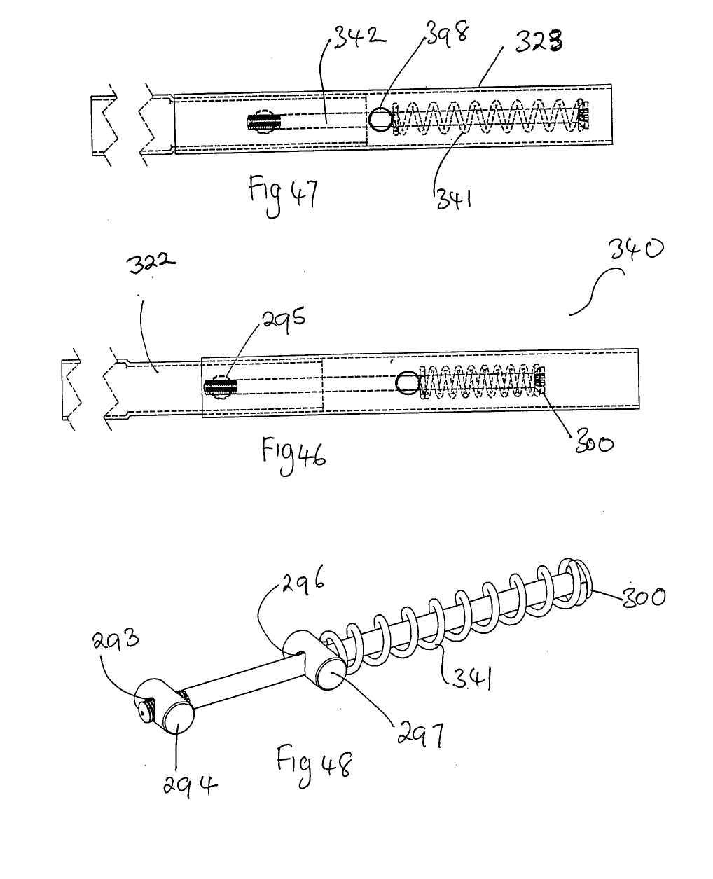

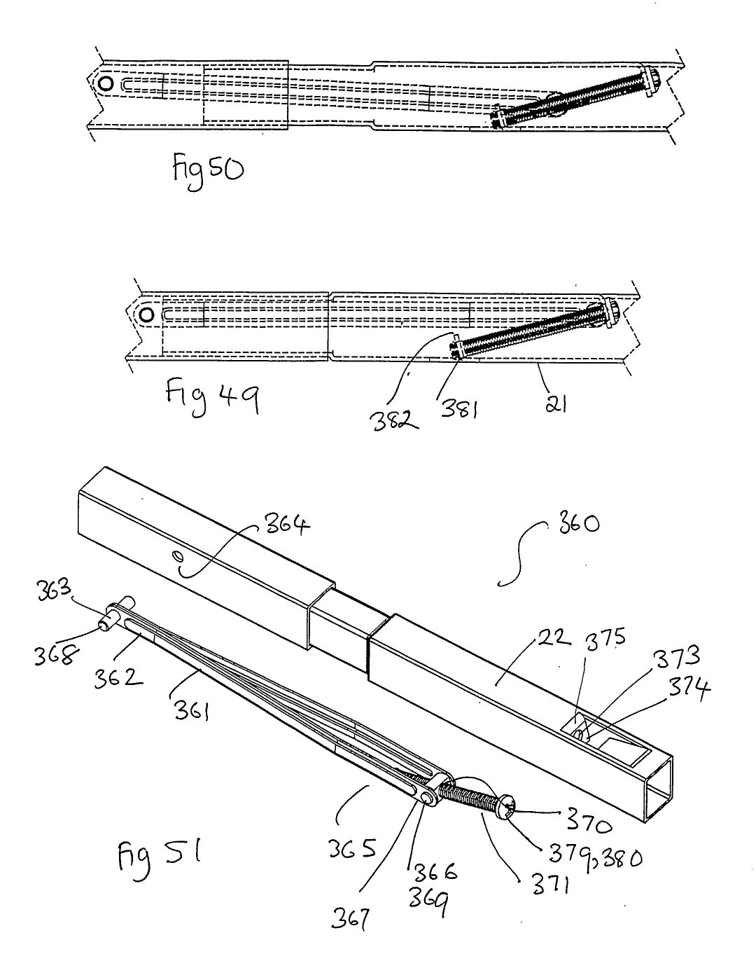

In some forms, the opposed inner surfaces of sides 7 are inclined inwardly from the base 8 (FIGS. 4 and 5) so that the sides 7 have to be separated by force to accept the outer frame members 17, a result of which, the sides 7 press inwardly on the outer frame 20. The frames may be further configured to ensure that the inner frame 3 is in contact with the outer frame 20 along its periphery; the frames may also be configured to preclude openings between the frames through which insects, breeze or water may pass and into which tools may be inserted during forced entry. In some forms, the outer edges of the sides 7 have slightly inwardly protruding shoulders 9 that extend along the entire periphery so that the sides 7 only abut the outer frame 20 along the shoulders 9 which in some forms, are urged against the outer frame 20 as described above. In some forms, the opposed shoulders 9 include a gasket 10 to interface with the outer frame 20, the gasket providing a better seal and/or reduced friction enabling the outer frame 20 and inner frame 3 to relatively displace at reduced forces as occurs during adjustment at fitting. In some forms, the opposed shoulders 9 include a longitudinally elongated recess 11 to receive and retain a gasket comprising an elongated resilient sealing member that may comprise a rubber or plastic cord or fibrous strip, the recess 11 being characterized by a width w1 and an opening 12 of reduced width w2 as shown in FIG. 7.

In some forms, the inner frame is comprised of elongated inner frame members 13 that are connected to extend along the entire periphery of the infill and in some forms, the ends of the inner frame members 13 are connected at corners 16 that in some forms enable the channels 5 [of connected inner frame members] to be connected to form a continuous channel 15 that extends along the entire periphery of the inner frame 3 by extending around each corner 16.

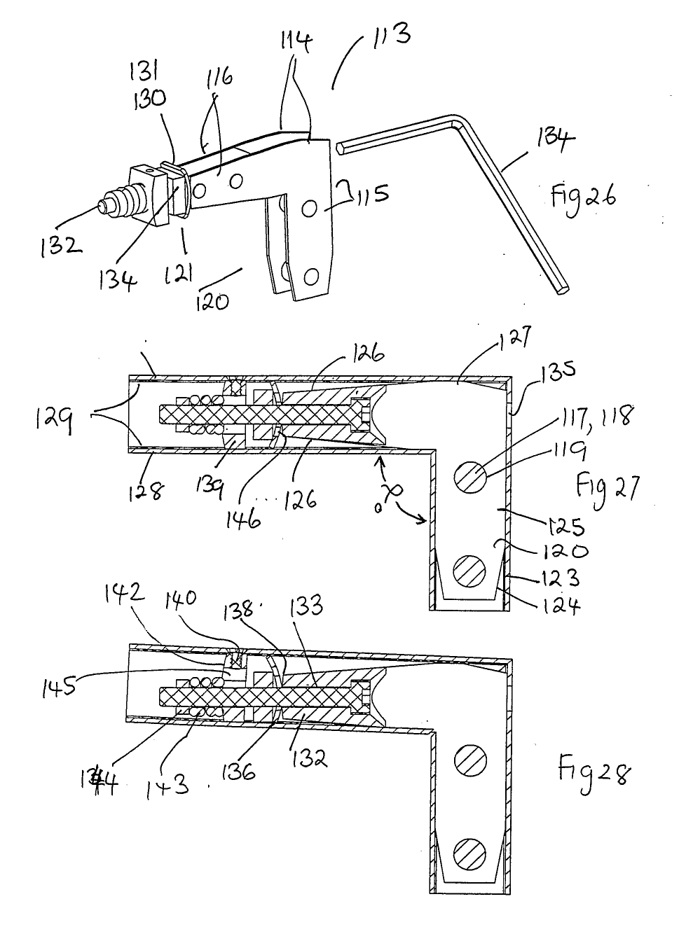

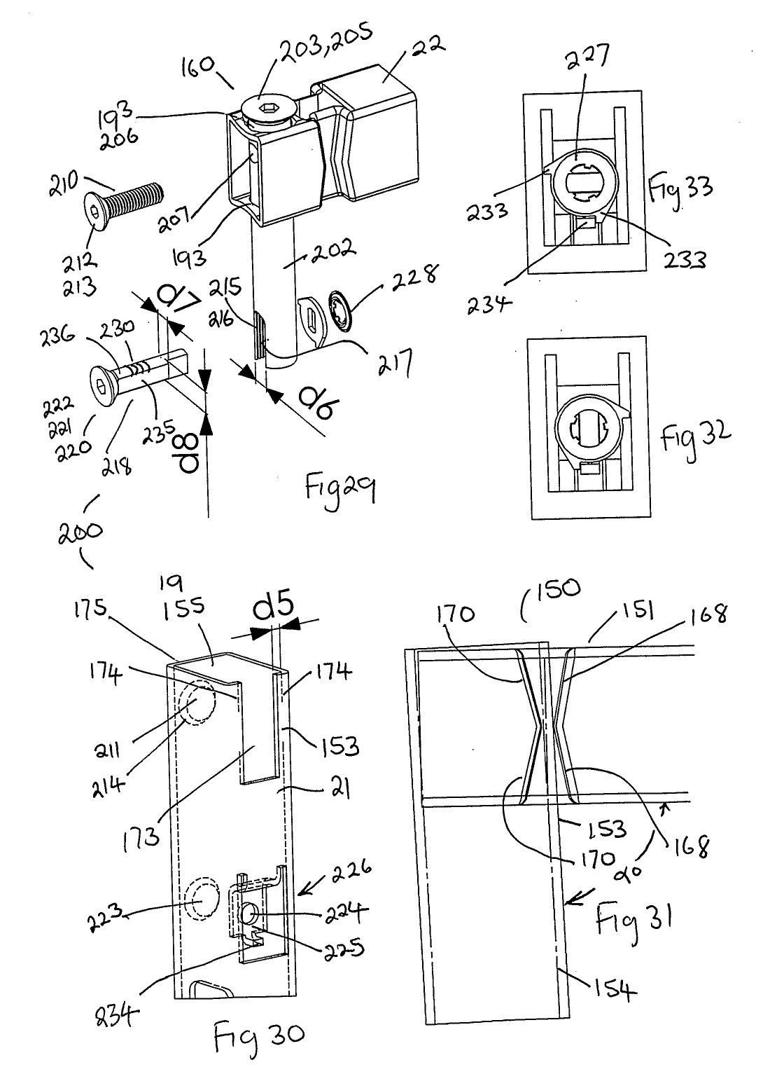

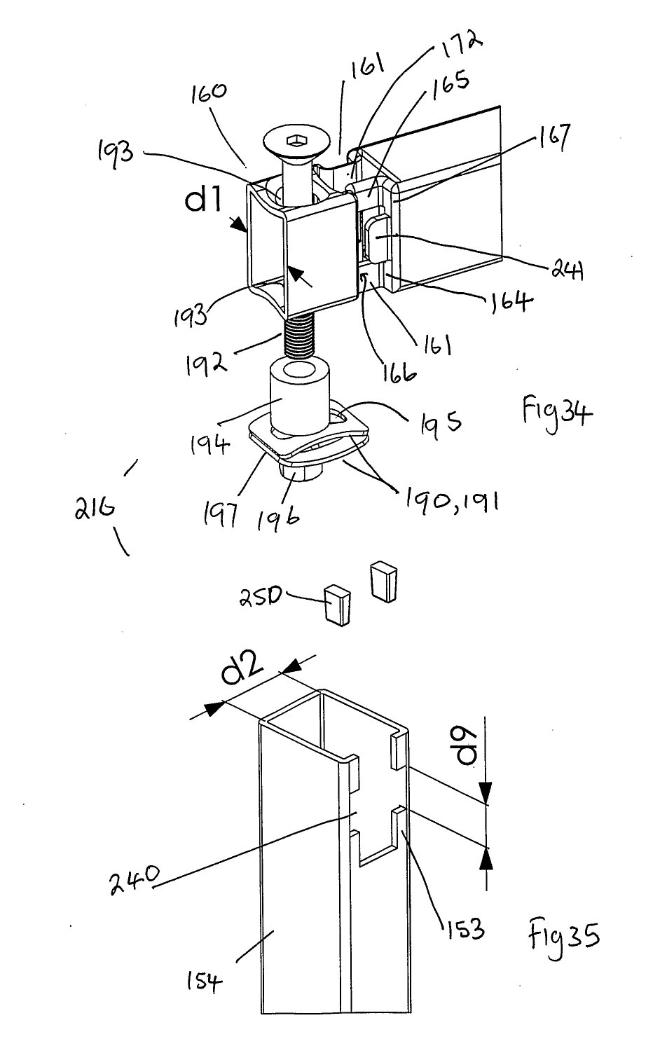

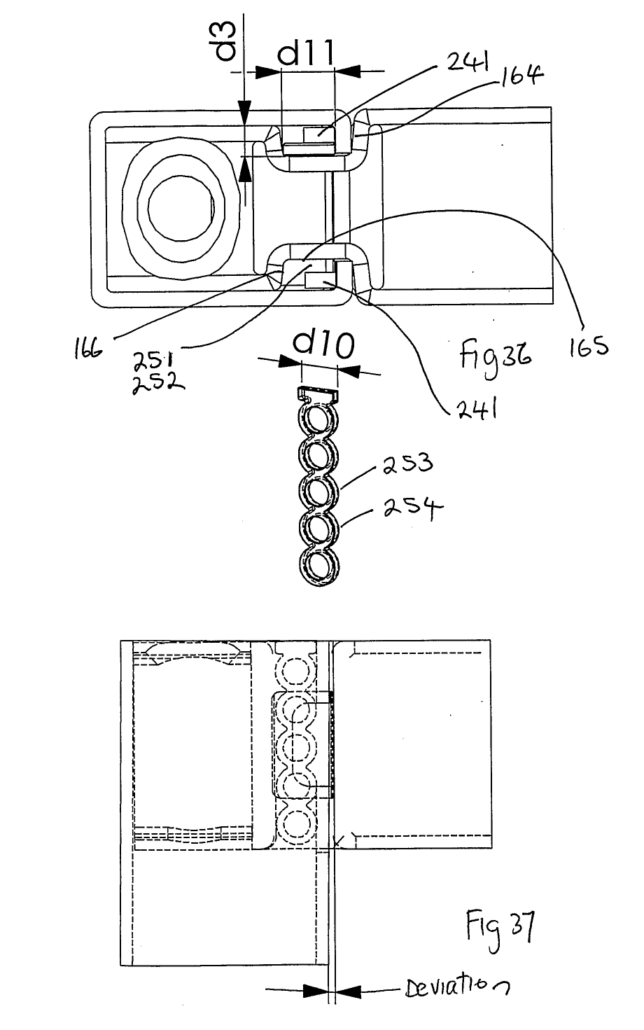

The outer frame 20 and infill 2 overlap each other and in some forms, the outer frame extends along the entire periphery of the infill. In some forms, the outer frame includes one or more straight elongated hollow outer frame members 17 that in one form are characterized by having a substantially rectangular cross section with a longitudinal recess 19 defined between the opposed sides 18 and opposed inner edge 21 and outer edge 22 as shown in FIG. 3. The hollow rectangular outer frame members may be manufactured from any suitable material and in some forms, are manufactured from drawn steel tube or aluminium extrusion as shown in FIG. 3. In other forms, the outer frame members are configured as rolled section 34, as shown in FIG. 4, having an elongated slot along the inside edge 21 but otherwise being configured as the hollow tube. The outer frame members may have different cross-sections but in a particular form, they are all characterized by a uniform substantially rectangular cross-section [defined by an edge depth “D”, a side width “W” and a side-wall thickness “t”] and by longitudinal axii that share the same plane. In a more particular form, D=19 MM, W=25 MM, t=1 to 2 MM, as shown in FIG. 11. In some forms of wings, the outer frame width W (FIG. 11) is substantially the same as the channel depth (FIG. 7). The inventions, within however, are not limited to wings having this particular form nor the uniformity described above nor in fact to a substantially planar wing having a substantially planar infill which forms are embraced by the inventions within.

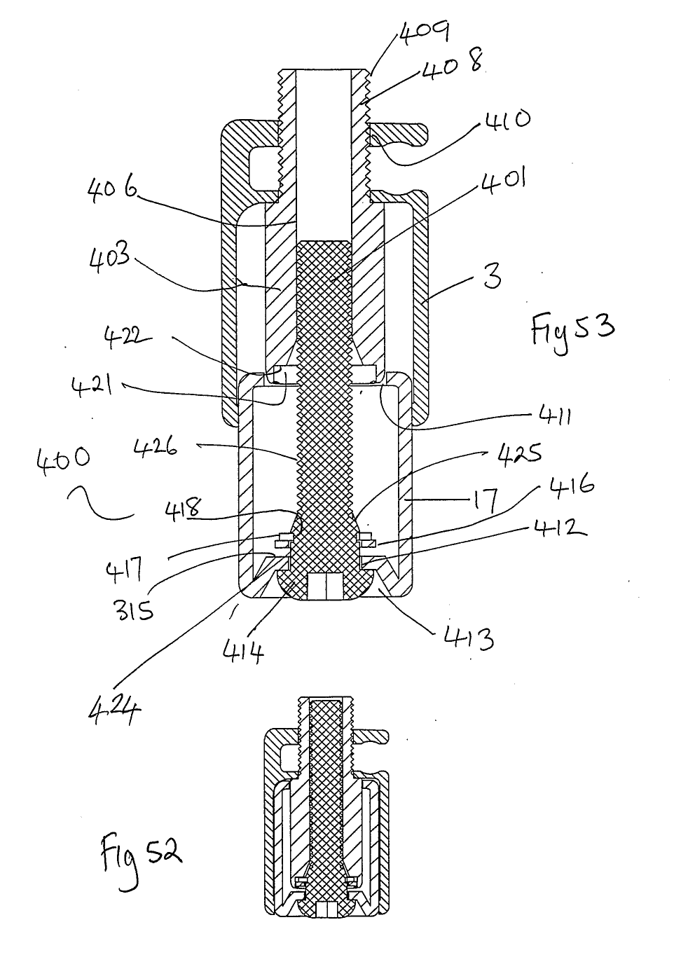

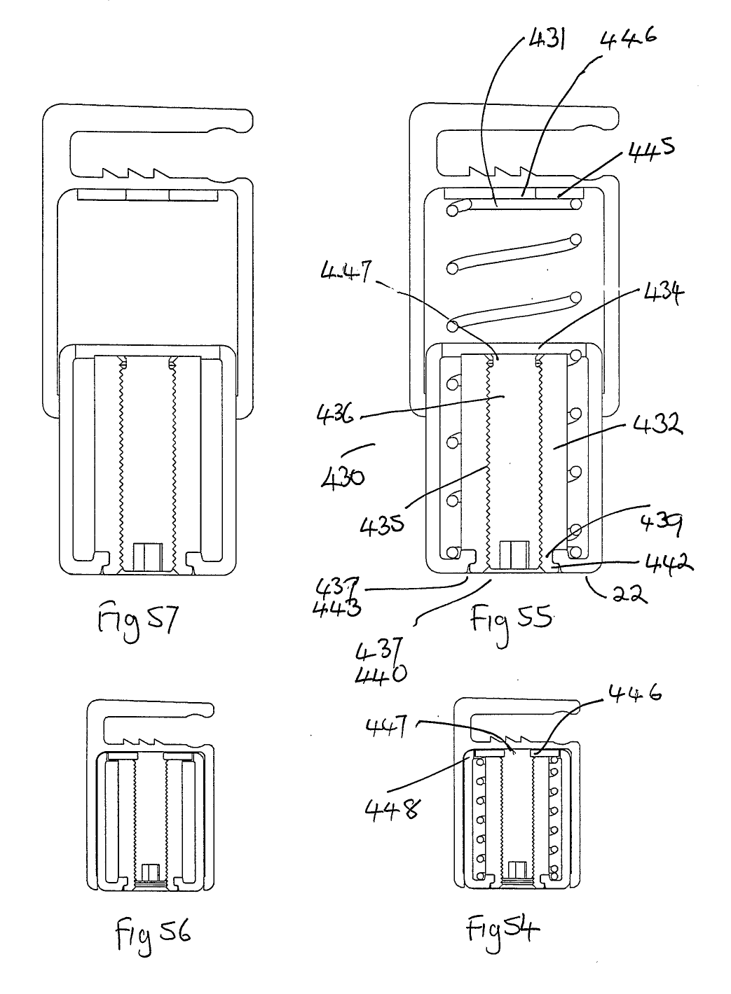

In some wings, at least one outer frame member 17 includes a pair of outer frame portions joined by a linear joint as shown in FIG. 38 to 51, that may be adjusted to change the length of that outer frame member 17 and in some wings, all the outer frame members 17 include an adjustable linear joint. In application, the outer frame members are adjusted (from their minimum lengths) to an increased length to increase the extent of the wing to make it more suitable for an opening of larger size (the objective being to fill the opening with the wing with working clearances).

In some wings, after the wing has been adjusted to a larger extent the outer frame members are parallel to their respective configurations in the smallest configuration, in which case, the corner joints can be configured as perfect joints as defined below. In some cases, the outer frame members will become not parallel to their respective configurations in the smallest configuration resulting in the corner joints having an included angle that differs from a nominal angle—some of the inventions within providing corner joints that substantially maintain their integrity when adapted to become “imperfect” as defined below.

The outer frame members 17, are connected by corner joints 23. In some forms, each is adjustable to vary the “included angle” [“Alpha”] at which the two outer frame members 17 participating in a joint, are relatively disposed; these joints 23 comprising either a mortise or butt joint as described below. In some forms, the corner joints are configured such that when the wing is in its smallest configuration the corner joints are “perfect” having an included angle equal to a “nominal angle” and where the wing includes an inner frame, each outer frame member abuts (along its entire length) the inner wall of the base 8 of a corresponding inner frame member 13.

In a mortise joint (FIG. 26 to 28) the perfect joint is further characterized by the outer frame members being in contact along an entire edge and without creating a visible wedge-shaped gap and in a simple butt joint (FIG. 34) having a straight first end walls 164, the perfect joint is further characterized by the first end wall 164 being in contact with the second outer frame member other along its entire length and without creating a visible wedge-shaped gap while an adapted form of buff joint (FIG. 29) has a first end wall 164 consisting of angled portions that in a perfect joint, are equally inclined to the edge portion 153 of the second outer frame member.

In some forms of wings, each corner joint remains adaptable till a corner fastener is tightened to render the corner joint rigid.

A particular form of wing includes an infill bounded by an inner frame on all sides that is bounded by an outer frame on all sides. A more particular form [defined as a “rectangular wing”] is characterized by the inner frame being substantially rectangular and the outer frame having:

a) a smallest configuration where each outer frame member abuts (along its entire length) an inner wall of the base 8 of a corresponding inner frame member 13, and

b) a nominal angle of ninety degrees at each corner,

In a particular form of rectangular wing (that may be included in a window screen or door) it is desirable for the inner and outer frame members 13,17 to have minimum widths: a competing consideration however, requires the widths to be large enough to enable the wing to be adjusted in extent to embrace a pre-determined range of opening sizes A more particular objectives of the inventions within, is for a single door to embrace a range of common openings. In a more particular form again, the wing comprises a security door that is adaptable to embrace common security doors in Australia that have a height “H” between 2010 and 2050 (where the incremental height h=40) and a width “W” between 800 and 830 (where the incremental width w=30).

By way of example, where the minimum acceptable overlap is 5 MM and where half of the increments [h/2 and w/2] derive from opposed sides of the wing, the channel 15 depth (shown in FIG. 7) is required to be w= or >25 MM (40/2+5) and the width of the outer frame is correspondingly required to be at least 25 MM. In a particular form, it is configured as substantially 25 MM.

If such a wing is skewed by 10 MM so that the outer frame member 17 supporting the lock is 10 MM lower after fitting (than it would be if the door remained rectangular), then the widest part of the gap in a mortise joint will be approximately 10×1.414×25/800 MM and the widest part of a simple butt joint (having a straight first channel edge 166) will be approximately 10×25/800 MM—both very small amounts indeed and other wings characterized by similar ratios will have corresponding similar gaps. The corresponding deviation would be 10×180/800×Pi degrees [approx ¾ of a degree]. Although joints could be configured to accommodate larger deviations, it is envisaged that in practice where the inventions are further configured to be doors, the deviations will be within the range −3 degrees to +3 degrees.

Although these gaps are unfortunate, they are preferable to the common solution of fitting a rectangular door into a skewed opening to have gaps through which insects have passage and/or where security is compromised.

It should be said that the smaller is the width of the outer frame, the smaller will any corner gaps be for a give angle of skewing and this is another reason for minimizing the width of the outer and inner frame members.

### Locks

Where a wing includes a lock, the closing edge outer frame member is configured to receive and support the lock. A particular preparation includes a cover 28 comprising spaced plates 29 (having outer surfaces 30 that substantially lie in the same planes as the surfaces 31 of the sides of the closing edge outer frame 20), that extend inwardly from the inside edge 21 of the outer frame 20 to (together with the closing edge outer frame) provide a surface 32 on which to mount the lock or unlatching-handle back plates 33 of the lock. Once mounted, some lock portions may extend through side apertures 27 in the combined closing edge outer frame 20 and cover 28 described below. In a particular form of lock, a lock body 24 is mounted within an outer edge aperture 25 of the outer frame 20 and it may extend through an opposed aperture 26 in the inside edge 21 of the outer frame 20, as shown in FIGS. 12 and 13. In some forms, the lock is configured as an Australian conventional security door lock able to fit within an industry-standard door preparation and having a lock casing having dimensions as defined above.

Where an inner frame is included, the surface 32 extends horizontally and vertically so as to be accessible and un-obscured by the inner frame member (or its associated hump) in all possible configurations of the wing and in all configurations providing an accessible surface on which to mount the lock or unlatching-handle back plates 33 as the lock requires. In some forms, the plates 29 are connected by a return to form a substantially U shaped member [that may be attached by welding] that envelops the opposed aperture 26 and the protruding portion of the look body.

The cover 28 may be rectangular in side view but it may be configured in part, to suit a hump 35 of the inner frame 13 that is configured in that form for ease of manufacture where the hump is made by forming (by conventional means that may comprise rolling and/or drawing) the inner frame to have an upper angled portion 36 and a lower angled portion 37. In this case, the cover 28 includes an upper angled extension 38 that extends inwardly and downwardly and lower angled extension 39 that extends inwardly and upwardly to be overlapped by the “hump” 35. The hump 35 may have curved portions at the ends of the angled portions, in which cases the upper and lower angled portions of the cover 28 would be similarly profiled. The cover 28 however, may be fabricated to be rectangular in form (when viewed from the side) and may comprise an open sided substantially rectangular hollow member and may comprise a metal or plastic casting.

Importantly, where an inner frame is included, the outer frame member 17 and cover 28 together are overlapped along their entire inner edge by the infill 2 and hump 35 together to preclude openings through which insects, breeze or water may pass and into which tools may be inserted during forced entry

### Centralizing the Infill

In some forms, as shown in FIG. 9, an inner frame 3 and outer frame are coupled by elongated that may comprise pins 40 that extend inwardly from the inner frame 3 adjacent to each corner 16, each pin extending into an associated recesses 41 in the side of the outer frame 20 that extend laterally and longitudinally to enable the pin 40 to always occupy the recess 41 in any configuration the wing may assume [in a particular wing h/2=1 to 20; w/2=1 to 15] to ensure the inner frame 3 and outer frame 20 always overlap each other along the entire periphery of the inner frame 3. Each pin 40 may be configured as a pin having a cylindrical shank and a threaded portion adjacent to a head, to engage in the aperture in the inner frame and each may actually just comprise a screw and in usage, they would be applied to the wing before the wing is adapted in extent.

The pins 40 and recesses 41 do not ensure the infill 2 is centrally located and in some cases (and particularly where aesthetics is important) this is a requirement. In these and other cases, where it is a requirement that irrespective of how the outer frame 20 is adjusted (within its range of possible configurations), the infill remain substantially centrally located relative to the outer frame 20, coupling is provided between the inner 3 and outer frames 20.

The coupling in some forms comprises one or more linear joint each including a pair of identical opposed compressed compression springs that act to urge the infill 2 towards the centre of area of the associated outer frame member. In other forms, each end of one or more outer frame members 17 is coupled to the adjacent inner frame member 17 by means including a threaded fastener where rotation in one direction causes the associated outer frame member 17 to displace towards the inner frame 3 and when rotated in the opposite direction, causes the outer frame member 17 to displace away from the inner frame 3 [this mechanism requiring the fitter of the wing to manually adjust each orthogonal joint]. In yet another form, each end of each outer frame member 17 is coupled to the adjacent inner frame member 13 by means including opposed compressed compression springs that act to urge the infill towards the centre of area of the outer frame. These are described in detail below.

### Infill

The infill may be configured to include a deformable infilling material 45 such as sheet metal, as shown in FIGS. 14 and 15 (that may be perforated) that in one method of attachment is connected to the inner frame 3 by an edge return portion 46 that extends orthogonally to extend into an orthogonal fixing channel 47 (FIG. 7) of the inner frame 3 to be secured there by a fixing wedge 93. The fixing channel 47 is formed between the outer wall of the base 8 and a fin 48 spaced inwardly from the base 8. The fixing channel extends sideways from a side opening 49 and in one form, has on one side, a ramped surface 50 that includes inclined surfaces (that extend towards the fin 48 as it/they extend into the fixing recess) and the elongated fixing wedge 48 includes a mating ramped surface 51 that extend away from the fin 48 as it/they extend into the fixing recess and towards a leading edge 52 of the fixing wedge which is inserted into the fixing channel 47 first—the components preferably being configured such that as the fixing wedge is driven in, the fins 48 displaces elastically away from the base 8 to enable the high ridges 53 on the fixing wedge 48 to displace over the high ridges 54 of the fixing channel 47. When installed the high ridges 53 lie inwardly of the high ridges 54 to retain the fixing wedge 48 within the fixing channel 47. The fixing channel 47 is preferably further configured to have a width such that the fixing wedge 48 exerts a sideways force on the return portions 46 in the finished wing. The return portions 46 in some forms, includes a secondary return portion 55 parallel the face of the infill 2, which when installed, abuts the leading edge 52 to better secure the sheet metal 45.

In some forms, as shown in FIG. 16, the return portion 46 is enveloped by a U shaped resilient or elastic grommet 66 (that in some forms is comprised of rubber, latex or plastic) that extends the entire length of the return portion to maintain the infilling material 46 separated from the inner frame 3 to amongst other things, impede galvanic corrosion between the infilling material 46 and inner frame 3 when the materials are different. Similarly, if the secondary return portion 55 is employed, the grommet 56 is configured to have an L shaped return 92 that overlaps the return portion 55, to amongst other things, restrict galvanic corrosion.

The infill may include other material 57 not easily connected by the means described above such as woven mesh 58 or glass 59 attached to the inner frame 3 by extending into a lateral fixing channel 60 in the inner frame 3 to be secured there by a resilient or elastic grommet 61 that amongst other things, acts to separate the other material 57 from the inner frame to amongst other things, impede galvanic corrosion, as shown in FIG. 17. The lateral fixing channel 60 is formed between two inwardly extending (substantially parallel) fins 62 that extend from the inner wall of the base 8. The lateral fixing channel in one form has on one side (and in some forms both sides), a ramped surface 63 that includes one and in some forms multiple, inclined surfaces that extend towards the fin as it/they extend into the fixing recess 60—the components being configured such that as the “sandwich” of grommet 61, infilling material 57, grommet 61 are driven together into the lateral fixing channel 60, the grommet elastically deforms to subsequently occupy the recesses behind the high ridges 64 of the lateral fixing channel 60; the grommet 61 in the assembled infill exerting an outwards force on the walls of the lateral recess and ramped surface 63 while exerting an inwards force on the other planar material 57.

The infill 2 may be configured to include bars 65 as shown in FIGS. 18 and 19, connected by fasteners 66 that extend through apertures 75 in the base 8 and fin 78 to occupy an elongated axial aperture 76 in an axially elongated shank 77 of an associated cap 67 associated with each bar end as described below. In some wings, each bar has an elongated axial recess 68 at each end that may be configured as hollow tube 69 having a continuous axial recess 70 and in some infills, the fixing channel 47 supports an elongated stiffening member 71 having inwardly extending apertures 72 that each extend from a conical recess 73 configured to receive the countersunk head 74 of a fastener.

Each cap 67 has a shank 77 having an outer surface that substantially conforms to the recess 70 of the bar and preferably having a cupped head 78 having a side wall 79 that extends a short distance up the exterior face of the bar 65 to obscure its end. In application, the cap 67 may be applied to the recess 70 by being forced into it to elastically deform the bar 65 and/or the shank 77 that may have a weakened side portion (not shown) that is driven outwardly by fastener insertion as do many common fixing plugs and/or the shank 77 may include a side recess into which a side portion of the tube 69 is formed. In some wings multiple tubes 65 form a grill 82, and in some forms, some bars include an offset portions 83 configured to straddle other bars.

The infilling material may be mesh 84 as shown in FIGS. 20 and 21, that may comprise fiberglass mesh 85 mounted to the inner frame 3 by a common method including the insertion of an elongated resilient spline 86 into a spline channel 87 (FIGS. 21 and 6) in a side of the inner frame 3. In some forms, the spline channel 87 comprises a portion of the fixing channel 47 that may be configured to have concave side portions 88 separated by a distance substantially the same as the width of common spline channels in security doors.

In some forms, as shown in FIGS. 8 and 26 to 28, the inner frame includes inner frame members 13 connected by corner joints that comprise a mortise joints that in some forms includes a joining member 90 having legs 91 that occupy the fixing channels 47 of the connected inner frame members 13 and in a particular form (FIG. 21), each joining member 90 is configured to only occupy the bottom of the fixing channel 47 to provide space above that, to be occupied by the a reduced height fixing wedge 93.

In some forms of the wing, the infill 2 is configured to be rectangular and in some forms it includes an inner frame 3 where each corner joint 16 is configured as an orthogonal mortise joint.

The inventions within also provide a wing having an infill that includes multiple spaced bars 480 each having an end that extends freely into an aperture 481 within the inside edge 21 to overlap the outer frame (to provide limited relative displacement between the end of the bar and outer frame member); the bars together being supported relative to the outer frame which is adjustable in length (through linear joints described below) and/or relative angular disposition (through adjustable corners as described below) (FIG. 59). In some forms, the bars comprise rectangular hollow members having a leaf spring 484 supported within each end that protrudes from the end and an angled return portion 483 extends sideways to protrude from the side of the bar to overlap the material forming the peripheral edge of the associated aperture 481; it is retained attached by a headed rivet 485 that extends through the spring 484 and side wall of the tube in conventional manner.

In another form having multiple spaced bars 486 (FIG. 60) each bar has an end attached by a pin joint 487 to the outer frame (the pin joint accommodating limited relative angular displacement) and each bar within its length includes a telescopic joint 488. In one form, each bar consists of a pair of overlapping strips 489 while the telescopic joint includes elongated axial apertures 490 in one strip through which cylindrical rivets 491 extend to be fixed in circular apertures 492 in the other strip, the rivets having heads 493 that overlap the walls of the axial apertures and which retain the strips adjacently disposed over the range of relative dispositions provided by the apertures and where one or more pairs of opposed outer frame members are adjustable in length (through the inclusion of linear joints) and where one or more pairs of corner (that include mortise or butt joints) are adjustable to vary the included angles.

### Knock-Down or Do-It-Yourself “DIY” Version

In some wings that may be further configured as doors or screens, the infill is configured as multiple smaller sub-infills 100, as shown in FIG. 22 to 25, to enable the wing to be supplied in a “knock-down” form and to fit within a carton or other packaging form suitable for retail sales outlets: the wing being assembled by the home owner at a later time. In some “knock-down” forms, the infill comprises a pair of substantially identical sub-infills as shown in FIG. 23.

In some forms, an inner frame members 104 (of the first sub-infill) and inner frame members 104 (of the second sub-infills) (FIG. 25) are adjacent and overlap a central strut 106. Each inner frame members 104 and 105 is intersected by an orthogonal pin 107 that extend to mate within axially aligned apertures 108 in the strut 106 to restrain the sub-infills against relatively sliding while a U shaped cover 109 acts to restrain one sub-infill from displacing away from the other. In other forms, as shown in FIG. 24, the sub-infills are connected by a central hinge 101 having a first leaf 102 connected to inner frame members 104 and a second leaf 103 connected to inner frame members 104, so that during assembly the two sub-infills simply hinge open to form a single infill.

In some orthogonal wings, the longer outer frame members 110 (having a length L₁) are configured to fit diagonally in a carton by having lengths l=sq root [(L₂²+(L₁/2)²] and (L₁−l). Where the wing comprises a common door having a height H=2010 MM and a width W=820 MM, each longer outer frame members 110 is configured as first outer frame portion 111 having a length equal to the diagonal of a sub-infill, =[sq root (1005²+820²)]=1.33 M and a second outer frame portion 112 of (2010−1330)=0.680M; these outer frame members clearly fitting within a carton that will fit with a sedan vehicle.

Manufacturing the infill as similar or differently configured sub-infills also provides the manufacturer with an opportunity to manufacture a variety of wings from common elements and to better rationalize the manufacturing process.

### Mortise Corner Joints

In some wings, some outer frame members 17 are connected by mortise joints as shown in FIG. 26 to 28, that includes a corner connector 113 that enables the included angle to be adjusted to slightly vary from the nominal angle, in one form, the corner connector comprises a pair of plates 114 having pairs of legs relatively disposed at a pre-determined disposition, a first legs 120 having outer surfaces 115 separated by a distance substantially the same as the distance between side walls 18 of a first outer frame member 17, a second leg 121 having outer surfaces 116 separated by a distance substantially the same as the distance between side walls 18 of the second outer frame member 17. In some forms, the plates 114 are supported and separated by multiple spacer members 117 that may comprise single castings having opposed extensions configured as including rivets 118 at each end that each extend through a mating apertures 119 in the sides of the plates 114 to be peened over whereby to become fixed relative to plate 114.

The first leg 120 is configured to be a tight press fit into the first outer frame member 123 by dent of a tapered leading end 124 (of width a little less than the distance between edge walls 21 of the first outer frame members 123) connected to a portion 125 of greater width requiring the first outer frame member 123 to elastically deform to receive the leg 120.

The second leg 121 has continuously tapered sides 126 connected to a short portion 127 of greater width, the second leg 121 being received into the second outer frame member 128. The second outer frame member may is some forms be required to slightly elastically deform to receive the connector not so as to give rise to forces that significantly affect the action of the spring described below. The second leg 121 is angularly displaceable between the limit set by the tapered sides 126 abutting the internal sidewall 129.

The second leg 121 supports one or more curved fixing members 130 (that may comprise hardened pressed metal parts 131 having sharp edges) each having a projection substantially the same as (or a little greater than) the cross section of recess 129.

The fixing member/s is/are supported about a threaded mortise fastener 132 that extends through elongated apertures 146 in the fixing members 130 to engage in a threaded aperture within a tension plate 134 supported adjacent to the fixing member/s. The apertures in each fixing member are elongated in a direction parallel the face of the wing (as shown in FIG. 27) so that once received within the recess 129, the fixing plate/s 130 are supported by the second outer frame member to be displaced with the second outer frame member. The mortise fastener is supported within an apertures 133 (through which it extends without or with minimal clearance) in the end spacer 132.

In usage, the assembled outer frame is displaced to have the desired included angles at each corner, after which the mortise fastener is rotated (by inserting a tool 134 through an edge aperture 135 in the outer frame member 17) to cause the tension plate 134 to be displaced towards the fixing members 130 to cause it/them to deform towards their straightened form and in so doing, to displace their outer edges 136 outwardly into contact with the internal walls 129 of the recess 19 and in some cases to elastically deform the outer frame members; at the same time, the nut tension plate 134 and end spacer 132 are urged relatively towards the fixing member/s 130 to a generate frictional reaction force that resists sideways relative displacement between the longitudinal fastener and fixing members 130. Tightening of the fastener thereby rigidly fixes the end of the mortise fastener relative to the second outer frame member to resistant reconfiguration of the outer frame from the configuration it was at the time of fastener tightening.

In some forms, the abutting face of the fixing member 130 and leading end 138 of the spacer are ramped or otherwise similarly interrupted to better resist relative displacement.

In other forms, a fixing block 139 is fastened to the outer frame member 17 by the fastener 140 that extends through apertures in the side of the outer frame member 17. The fixing block 139 has an inner surface 142 (that is curved to be defined by a constant distance from the centre of the orthogonal that extends between the ends of the angled corners of the outer frame members 19) on which a compressed compression spring 143 acts to urge the fixing block and second outer frame member 128 towards the corner; the spring 143 being retained on the mortise fastener between the end nut 144 (that has a width that precludes rotation relative to the outer frame member 17) and the fixing block 139.

The fixing block has an oval aperture 145 to provide passage for the fastener and to allow the fastener (within the corner connector 113) to displace relative to the fixing block and second frame member 128 by displacing in a plane parallel the face of the wing. The spring 143 is preferably sufficiently strong to retain the outer frame members in constant contact even as the outer frame is adjusted.

In application, the first leg 120 is pressed into the first outer frame member 123 and the second leg 121 is applied to the second outer frame member 128 with the compression spring 143 uncompressed and the nut 134 abutting the fixing block 139. The fixing block is attached to this outer frame member 17 by the application of fastener 140 and the fastener is rotated to draw the end nut 144 to compress the spring 143 and to displace the tension plate 134 till it abuts the fixing member 130; the connector 113 being left in this configuration till after the wing has been adjusted, at which time the fastener 31 is turned to straighten the fixing member 130 as described above.

The springs 143 in each joint also act to urge each joint towards the nominal configuration because when the joint is displaced from the nominal configuration the connected outer frame members start to relatively angularly displace about one or other end of their angled ends to compress the spring 143 further, this action giving rise to a moment (that is proportional to the spring force and to the effective orthogonal distance between the fastener pivotal axis) that acts to urge the joint against displacing from the nominal angle.

### Butt Corner Joint

In some wings, some outer frame members 17 are connected by butt joints 150 as shown in FIGS. 10, and 29 to 37 where the end portion 161 of a first member 152 abuts an edge portion 153 of a second member 154 adjacent to an open end 155.

As stated previously, in simple “perfect butt joints”, the included angle at which the hollow members abut is the same as the nominal angle at which the first end wall 164 (which is straight) is disposed to the axis of the first member 152 and it abuts the second member 154 at all points along an edge. In all variations of the butt joint described within, the end portion 160 (of the first member) has a reduced edge depth “d1” substantially the same as the internal depth “d2” of the longitudinal recess 19 (FIG. 34, 35), to enable the end 160 to be received within the hollow 19. The first member 152 has (one and in some forms) opposed external side channels 161 that each include a floor 165, a second end wall 166 and a first end wall 164 that abuts the edge 153 of the second frame member 154. In some forms, each side channel 160 has an orthogonal cross-section that is substantially rectangular that may be characterized by corners 167 having a small radius; each side channel 160 having a depth “d3” (FIG. 36).

The first end wall 164 may be straight as described above or it may be substantially straight but adapted to include two angled wall portions, as shown in FIGS. 29 and 31 that meet in the middle of the side configured such that when the included angle is at either predetermined extreme disposition, an angled edge 168 of the first end wall 164, abuts the edge 153 of the second outer frame member 154—for consistency of description, it can be said that when the angled edges 168 are equally angularly disposed from the edge 153, the included angle is equal to the nominal angle.

The second end wall 166 in some forms is spaced from the internal wall 129 of the inner edge 21 of the second outer frame member 154 and in some forms an elastic, resilient or semi-resilient spacer, described below, is inserted to occupy this joint space to hold the first end wall 164 abutting the edge 153; in these forms, the second end wall 166 may be straight or consists of two angled edges 170, as shown in FIGS. 29 and 31; n other forms, an externally adjustable joiner (described below) is included to hold the first end wall 164 abutting the edge 153.

Where the first end wall includes angled edges 168 and the second end wall 166 includes similar angled edges 170, the angled edge 170 abuts the internal wall 129 to hold the first end wall 164 abutting (or in very close proximity to) the edge 153, as shown in FIG. 31; in these cases, the angled walls 170 and 168 are configured to meet in the middle of the side 18 and configured such that when the included angle is at either predetermined extreme disposition, an angled edge 170 abuts the internal wall 129 of the second outer frame member 154 and an angled edge 168 of the first end wall 164, abuts the edge 153.

Part of the butt joint lies in the second outer frame member 154 that includes a longitudinally elongated slotted edge aperture 173 in the inside edge 21 against which the first outer frame member abuts. In one form, the slotted edge aperture 173 commences at the open end 155 of the second member and extends longitudinally for a distance substantially the same as the width of the first outer frame member 152; the second member having a cross-section comprising a U shape with legs 174 of length “d5” protruding towards each other to form a restriction to the recess 19. In the assembled buff joint, the end portion 160 occupies the channel such that outer edge 22 of the first outer frame member 152 is co-planar with the end 175 of the second outer frame member 154 and the side channels 161 act to retain the outer frame members connected s described above.

The end portion 160 would be manufactured by:

1 Pressing or otherwise removing material from the edges 20 and 21 of the first outer frame member to provide opposed edge apertures 172 to selectively weaken the outer frame member to allow the adjacent sides 18 to be easily inwardly deformed.

2 Simultaneously forming the side walls 18 (adjacent to the edge apertures 172) to provide the opposed side channels 161 by placing a die within the first outer frame member to abut the internal wall 129 and pressing forming punches inwardly against external side walls of the first outer frame member 152 to cause the walls to inwardly displace to occupy a recess in each side of the die.

Some butt joints are further configured to include the following enhancing means to resist relative angular displacement between the outer frame members participating in a corner joint. For convenience, we refer to a Type A enhanced butt joint 216 [“TA Butt Joint”] that includes a pair of opposed curved fixing members 190 (that may comprise hardened pressed metal parts 191 having sharp edges) each having a projection substantially the same as the cross section of recess 19 so that once received within the recess 19, the fixing plates are supported by the second outer frame member to be displaced with the second outer frame member. The fixing members are supported about a threaded longitudinal fastener 192 that is angularly fixed relative to the end portion 180 (of the first outer frame member) by extending through spaced apertures 193 (without or with minimal clearance) in the end portion 160. A tubular spacer 194 is supported between the fixing members and portion 160 and a threaded nut 196 is supported adjacent to the other side of the fixing members 190. The apertures 195 in the fixing members through which the longitudinal fastener 192 extends are elongated to enable the fastener and fixing members to relatively displace; these apertures being elongated in a direction parallel the face of the wing as shown in FIG. 34, and perform a similar functions as do the apertures 146 of the mortise joint.

In usage, the assembled outer frame is displaced to have the desired included angles at each corner, after which the longitudinal fastener 192 is rotated by insertion of a tool into the drive recess to draw the nut towards the screw head to cause the fixing members 190 to be forced towards each other to cause them to deform towards their straightened form and in so doing, to displace their outer edges 197 outwardly into contact with the internal walls 129 of the recess 19 and in some cases to elastically deform the outer frame members; at the same time, the nut 196 and tubular spacer 194 are urged towards the fixing members 190 to a generate frictional reaction force that resists sideways relative displacement between the longitudinal fastener and fixing members 190. Tightening of the nut thereby rigidly fixes the end of the longitudinal fastener relative to the second outer frame member to resistant reconfiguration of the outer frame from the configuration it was at the time of fastener tightening; it should be noted that the nut is restrained against angular rotation by either being restrained against rotation relative to the adjacent fixing member 190 by having a protruding shoulder that overlaps the wall of the aperture 195 or being restrained against rotation relative to the second outer frame member by having a side which abuts to extend along an internal wall of the side of the hollow 19.

Alternatively, some butt joints are further configured as a TB enhanced butt joint 200 [TB Butt Joint”] as shown in FIG. 29 to 31 that includes a corner stiffener 201 that extends longitudinally into the elongated recess 19 of the second outer frame member 154 and that is angularly fixed relative to the end portion 160 (of the first outer frame member 152) by extending through spaced apertures 193 (without or with minimal clearance) in the end portion 160.

The corner stiffener 201 in one form, includes an elongated substantially cylindrical portion 202 and a head 203 (that may be of reduced diameter that protrudes through aperture 193 in the outer edge 22 to be peened over to effect connection between the corner stiffener 201 and end portion 160 (Not Shown); or the head may have a substantially conventional countersunk head 205 supported in a mating countersunk recess 206 in the outer edge 22.

The corner stiffener 201 may be employed along with a joint spacer 250 but in other forms an associated corner stiffener 201 is employed and the corner stiffener 201 includes a threaded side aperture 207 located between the spaced apertures 193 and preferably equally spaced between these apertures 193; the aperture 207 receives the threaded shank of a joiner 210 that extend axially through an aperture 211 in the outer edge 22 of second outer frame member while its head 212 is retained relative to the outer edge 22 to be accessible to be rotated by a tool. In some forms, the head 212 is configured as a pan head supported within a head recess (not shown but configured to receive and house the head) formed in the external edge 22 and in some forms the head recess and aperture 211 are longitudinally elongated (in a direction parallel to the axis of the second outer frame member) and the floor of the head recess is defined by a radius centred at the centre of the first end wall 164 to better enable the corner stiffener to be incrementally angular displaced about the centre of the first end wall 164. In other forms, the head 212 may have a substantially conventional countersunk head 213 supported in a mating countersunk recess 214 in the outer edge 22 and the threaded engagement between the joiner and stiffener 201 includes sufficient clearance to accommodate the deviation in the included angle.

The corner stiffener 201 also includes an orthogonal open aperture 215 disposed towards its other end that extends to the end of the corner stiffener 201 and that has substantially parallel sides 216 (spaced by a distance “d6”) that include longitudinally elongated blades 217 that extend towards each other from the opposed sides 216 to engage with the profiled shank 218 of an orthogonal locking key 220 that extends through this open aperture 215; it be will be appreciated, that the open end of the aperture enables the end portion 160 to be assembled to the second outer frame member (that includes the locking key 220) by enabling the open aperture 215 to be slid over the locking key 220.

The locking key 220 includes a head 221 that may comprise a substantially conventional countersunk head 222 supported in a mating countersunk recess 223 in the outer edge 22 of the second outer frame member 154 to be accessible to be rotated by a tool. The profiled shank 218 extends to the internal wall 21 and is some wings, it extends through an aperture 224 in an planar offset portion 225 of the internal edge 21; this displaced from the inner edge sufficiently to provide a pocket 226 to receive a control cam 227 and a circlip 228 configured to prevent relative longitudinal displacement of the locking key 220 (FIGS. 32 and 33).

The profiled shank 218 has a cross-sectional profile that is oval-like including opposed sides 235 separated by a minimum width “d7” (less than d6) and opposed side 236 (that may comprise part cylinders) separated by a distance (“d8”) greater than d6, as shown in FIG. 29. In some forms, the profiled shank includes multiple peripheral thread-like barbs 230 spaced longitudinally along its length and spaced to correspond to the spacings of blades 217 to provide peripheral channels 231 defined by a diameter substantially the same as “d6”. The elements are configured so that in usage, once the outer frame has been configured to have the desired included angles in the corner joints, the locking key 220 is rotated 90 degrees to cause the blades 217 to cut into the profiled shank 218 or the blades 217 to occupy the peripheral channels 231 to restrain the corner stiffener 201 against displacement relative to the locking key 220 and hence relative to the second outer frame member 154.

The control cam 234 has radially extending arms 233 configured to rotate only 90 degrees and further configured so that one end of the range coincides with an arm abutting a shoulder 234 of the landing 225 and the portion of the profiled shank of minimum width being adjacent to the blades; while the other end of the range coincides with the other arm 233 abutting the other side of the shoulder 334 and the portion of the profiled shank of maximum width being adjacent to the blades or teeth (FIGS. 32 and 33).

In some forms of the butt joints described above, the second end wall 166 is spaced from the internal wall 129 of the inner edge 21 of the second outer frame member 154 and an elastic, resilient or semi-resilient spacer, described below, is inserted to occupy this joint space to hold the first end wall 164 abutting the edge 153; while in other forms, the joiner is included to hold the first end wall 164 abutting the edge 153.

These forms of butt joint may be further configured as articulated butt joints that include a fin 241 of the first outer frame member that engages in a cross slot 240 of the second outer frame member (as described below) to prevent relative displacement). In these forms, an orthogonal rectangular slotted auxiliary aperture 240 intersects the slotted edge aperture 173 and that preferably extends sideways to the sides 18 of the second member 154, as shown in FIG. 35. The end of the first member is correspondingly modified by the inclusion of opposed locating fins 241 that extend longitudinally from each first side-wall 164 to extend into the auxiliary apertures 240. These fins 241 preferably have sides that taper outwardly from their free ends to a have a height at their bases substantially the same as the height (“d9”) of the mouth of the auxiliary apertures 240 so that once inserted, they act to restrain the first member against longitudinal displacement relative to the second member. The fins 241 are preferably further configured to be a mirror image about a plane that intersects the centre of the first wall 164.

The elastic, resilient or semi-resilient joint spacer 250 is inserted (in some forms by force) into the joint space 251 while the floor 165 abuts the end of the associated leg 241 while the first end wall 164 abuts the edge portion 153 of the second outer frame member 154. The joint spacer 250 abuts and acts outwardly on the inside wall 129 of the second member 154 while acting inwardly on the second wall 166 to urge the end portion 160 inwardly and it does so by occupying a space 252 beside the fins 241 and within the side channels 161, as shown in FIG. 36. In a particular form, the spacer 250 extends for the length of the side channel 161 where it is held compressed along its entire length and any relative angular displacement [deviation] gives rise to a moment urging the joint against deviating because deviation causes the spacer 252 to be further compressed at one end while the compression at the other end is reduced. In a more particular form, it comprises a resilient metal pressing 253 configured as multiple connected peripheral ovals 254 and having an undeformed width “d10” greater that the distance (“D11”) between second wall 166 and the inside wall 129 of the second member 154 requiring all the ovals 254 to be inwardly elastically deformed as it is driven into the joint space 251.

As stated above, butt joints including TA and TB butt joints may be further configured to have the articulated form. In particular forms of butt joints (suitable for orthogonal butt joints in particular), each longitudinal fastener 192 or stiffener 201 has a longitudinal axis that is orthogonal to the axis of the first outer frame member and the

TA and TB Articulated Butt Joints are assembled by:

a) Orientating the first and second outer frame members to have an included angle equal to the nominal angle and with their sides lying in parallel panes,

b) Aligning the end portion 160 substantially axially with the recess 19 but sufficiently offset to allow the fin/s 241 to pass along the outside of the second member, and

c) Displacing the end portion 160 into the recess 19 during which assembly, the legs 174 simultaneously slide relatively within the side channels 161 and adjacent to the second end wall 166 till the first outer frame outer edge 22 becomes aligned with the open end 175.

d) Advancing the first outer frame member towards the second outer frame member so the fin/s 241 enter the auxiliary apertures 240,

e) Inserting the joint spacers 250 or applying the joiners 210 and lightly tightening,

f) Adjusting the size and shape of the wing

g) Tightening the longitudinal fastener 192 in the butt joints or rotating the locking key 220, (dependent on which tightening method is employed) to render the joint rigid.

Articulated butt joints can be manufactured by:

1 Pressing or otherwise removing material from the edges 21 of the first outer frame member to provide substantially rectangular opposed edge apertures 172 to selectively weaken the outer frame member to allow the sides 18 (adjacent to these edge apertures 172) to be easily inwardly deformed. These edge apertures being located adjacently to the walls that will be deformed in step 2 below.

2) Press or mill out profiled substantially U shaped clearance apertures 259 adjacent to where the fins 241 will extend from

3) Forming the side walls inwardly by advancing a stepped forming punch towards an internal two part die—the punch and die being conventionally configured to form the side channels 161 at one level, while forming the fin 241 at another level.

4) Pressing or otherwise removing material to provide the slotted aperture 173 and if include, the auxiliary aperture 240

### Type-1 Linear Joint

Some wings include an operable Type-1 linear joint 270 [“L1 joint”] that provides coupling between the inner 3 and outer frames 20 through a pair of identical compressed compression springs 271 separated by fingers 272 that extends from the inner frame 3 as shown in FIG. 38 to 41, where the opposed springs 271 act to urge the interspaced fingers 272 towards the centre of the associated outer frame member.

In some forms, the linear joint 270 includes an operable mechanism within the recess 19 that includes a threaded plug 273 (having a threaded aperture 274) in which the threaded shank 275 of a fastener 276 engages. It is fastened relative to the end of a first outer frame portion 278 and a head plug 280 is fastened relative to the adjacent end of the associated second outer frame portion 279. The head 281 of the fastener 276 is fixed longitudinally relative to the head plug 280 to be accessible through an aperture 282 in the outer edge 22 of the second outer frame portion 279. The linear connector 270 may alternatively be configured to have a side aperture that is coaxial with an aperture in the side 18 of the first outer frame portion and that is accessible through an elongated side aperture in the inner frame.

The threaded plug 273 includes inwardly protruding feet 284 that occupy apertures 285 in the inner walls 21 of the first outer frame portion 278 and in some forms a nut recess 286 is included to accept a standard square or hex nut 287 with only limited clearance such that when engaged with the shank 275, the nut 287 cannot rotate relative to the threaded plug 273. The threaded plug 273 is intersected by an axial side aperture 288 configured to provide passage for the shank 275. The threaded plug 275 is configured to have offset side portions 289 configured to receive a U shaped member 290 such that when the threaded plug 273 is within the second outer frame portion 279, space 291 exists on three side that is occupied by the substantially U shaped member 290 that acts to retain the feet 284 within the apertures 285.

Similarly the head plug has feet 292 that occupy apertures 293 in the inner wall 21 of the second outer frame portion 279 and the U shaped channel 290 acts similarly to maintain the feet 292 within the apertures 293. The head plug 280 includes a head aperture 294 configured to accept the head of the fastener that is configured to have beveled peripheral gear teeth 295 that mesh with beveled gear teeth 296 of a tool 297 that can be inserted through the aperture 282 in the outer edge of the second outer frame portion 279 to be supported in a substantially cylindrical recess 298 having an open side 299 adjacent to the head of the fastener to enable meshing of the teeth 295 and 296; the tool being rotatable to rotate the threaded fastener. The head aperture 294 is intersected by an axial side aperture 301 configured to provide passage for the shank 275 of the fastener. In some forms, the head comprises a standard hex recess head 302 and a drive portion 303 having a hex protrusion 305 within the hex recess connected to a substantially conical portion 306 bearing the peripheral gears 295 retained in the recess by abutting a shoulder 307 of the wall of the head aperture 294.

Each linear joint is intersected by one or two fingers 272 that extends outwardly from the base 8 and which are attached to the inner frame by extending inwardly through rectangular apertures 310 in the base 8 and fin 48 of the inner frame member to be fixed relative to the inner frame: the fingers 272 extend outwardly to occupy the space 311 between the springs 270 (and adjacent to, one on each side if a pair the fastener 276), a space that is enveloped by the U shaped member 290 that acts to retain the fingers 272 so disposed.

The springs extend away from the finger/s 272 one to abut the threaded plug 273, one to abut the head plug 280, to bias the finger/s 272 towards the centre of the space between the plugs 273 and 280 whereby to bias the inner frame member 18 towards the centre of the associated adjacent outer frame member 20. When the wing has linear joints on each side, the effect of the multiple L1 joints is to bias the infill 2 substantially towards the centre of area of the outer frame 20.

Additionally, the wing may include within the linear joints a substantially U shaped cover member 312 having opposed legs 313 and an external form the same as the outer frame members 17, this member being supplied as an extrusion that is cut to length to suit each adjusted L1 joint; the cut length being forced over the U shaped cover member 290 and into the space between the ends of the first and second outer frame portions 278 and 279 to improve the appearance of the wing by giving the appearance of an uninterrupted member. In some form, the inside edge of each leg 313 has an inwardly extruding ramped fin 314 that terminates in an orthogonal shoulder 315 that in application, becomes adjacent to an edge of the U shaped member whereby to be retained attached to that member.

If the head aperture 294 is configured to have a sideways opening and the aperture 282 is a side aperture that extends from the plane of the wing (instead of edge) the tool may be inserted from a side and operated to adjust the length of an outer frame 17; as may occur with shutters; in this case the inner frame member includes an elongated slotted aperture coaxial with the head aperture configured to permit passage of the tool into the head aperture 294.

### Type-2 Linear Joint

Some wings include a Type-2 linear joint 320 [“L2”] that comprises a simple telescopic joint that includes a member that extends from a first outer frame portion 322 to within a second outer frame portion 323 and that mates with working clearance within.

In some forms, as shown in FIG. 42 to 45, a formed end 324 of a first frame portion 322 mates with working clearance within the end portion 325 of the associated second outer frame portion 223; the formed 324 being configured to have an effective outer cross-section substantially the same as the internal cross-section of end portion 325 within which it is received.

In some forms, the formed end 324 is further configured to include longitudinal channels 326 which support elongated bearing strips 327 (nylon or other such bearing material) that protrude from the side surfaces of the end portion 325 to abut the internal wall of end portion 325 to act as low friction linear joint. The end portion 325 and bearing strip 327 extend longitudinally for a distance greater than the adjustability required by the telescopic joints and preferably for a distance 4 times that.

Additionally, the L2 joint wing may include a substantially U shaped cover member 290 described above. The formed 324 end may be formed by:

1) Forming the sides 18 inwardly by pressing a stepped forming punch 330 inwardly towards an internal two-part die 331 to form the side channels 332,

2) Forming the edges 20 and 21 inwardly by pressing a stepped forming punch 333 inwardly towards an internal two-part die 334 to form the edge channels 336.

In a typical wing employing a L2 joint, a outer frame includes a first outer frame member connected at a first end to a second end of a second outer frame member, the first outer frame member including a L2 joint, the second end of the second outer frame member including an orthogonal joint that includes a fastener, that is operable to displace the second ends away from the first outer frame member to thereby lengthen the first outer frame member.

### Type-3 Linear Joint

The L2 joint 320 described above may be adapted to comprise a Type 3 linear joint 340 [“L3 joint”] that includes a compressed compression spring 341 supported about an elongated connector 342 to urge the second outer frame portion 323 towards the first outer frame portion 322—the connector 342 and spring 341 sharing a longitudinal axis parallel the adjacent outer frame member 17. The threaded end of the connector 342 engages in a threaded aperture 293 in a substantially cylindrical barrel nut 294 supported in and fixed relative to the formed end 324 (of the first outer frame member 322) by extending sideways to extend through circular apertures 295 in the sides of the formed portion 324. The connector extends longitudinally to extend through (with working clearance) a cylindrical aperture 296 in a second barrel nut 297 supported in and fixed relative to the second outer frame portion 323 by extending sideways to extend through circular apertures 298 in the sides 18 to support the spring 341 compressed between the second barrel nut 297 and a nut 300 on the end of the fastener 341.

The L3 joint is such that any displacement of the first outer frame member in relation to the second outer frame member causes the spring 341 to become further compressed, to an increased force resisting this relative displacement. The L3 joint may be further configured such that the forces exerted by the compression springs 291, are sufficient to displace the infill relative to the outer frame at all times (and to overcome any forces exerted by compression of springs within O2 joints described below)

### Type-4 Linear Joint

Some wings include a Type-4 linear joint 360 [“L3 joint”] as shown in FIG. 48 to 50 that include an elongated connecting arm 361 having a second end 362 intersected by a substantially cylindrical barrel 363 that is supported by the second outer frame portion 233 by having cylindrical end portions 368 that protrude through circular apertures 364 in the opposed sides 18 of that portion; the barrel being able to be angularly displaced relative to the second outer frame portion 323. The other end 365 of the connecting arm 362 is intersected by a substantially cylindrical barrel nut 366 that is supported about an obliquely disposed fastener 371, the barrel nut 366 having cylindrical end portions 369 that protrude through apertures 367 other end 365 to rigidly connect the two. The barrel nut 365 includes a threaded aperture 370 through which the fastener extends and with which it engages.

The fastener 371 is supported at both ends by the first outer frame member; it extends through an aperture 373 within a first landing 374 disposed orthogonally to the axis of the fastener, the first landing 374 being connected to the outer surface 22 from which is formed by a profiled surface 375; the first landing 374 being configured to enable a tool to be inserted into the recess 379 in the head 380 of the fastener which is supported on the landing 374 [i.e. so it can be operated from the side of the wing]; the other end of the fastener extends through an aperture 381 within an orthogonal second landing 382 disposed orthogonally to the axis of the fastener 371, the second landing 382 being connected to the inner surface 21 from which is formed; the fastener 371 including adjacent to the inner end, a circlip groove about which a circlip is located to retain the fastener. The components are configured such that when the first and second outer frame portions are in closest proximity, the barrel nut is adjacent to the underside of the first landing and when the first and second outer frame portions are furthest apart (within the limitations defined herein), the barrel nut is adjacent to the underside of the second landing. It will be appreciated that by turning the fastener, the first and second outer frame portions can be relatively disposed a required.

### Type-1 Orthogonal Joint

In some wings, each end of a frame member 17 is coupled to an adjacent inner frame member 13 by a Type-1 orthogonal joint 400 [“O1 joint”] that includes a threaded fastener 401 that can be rotated in one direction to cause the associated outer frame member to displace towards the inner frame 3 and rotated in the opposite direction causes the outer frame member 17 to displace away from the inner frame 3. As an end of the outer frame member displaces towards or away from the inner frame, another outer frame member 17 connected to the same corner is required to become either shorter or longer respectively and for this to occur a L2 joint within its length is required to displace provide for this change in length.

The Type-1 orthogonal joint 400, shown in FIGS. 53 and 52, includes an elongated shank 403 having an axial threaded bore (with threads 406 to mate with the fastener 401) connected at its inner end to a substantially cylindrical externally threaded (external threads 409) fixing stud 408 that engages within a threaded recess 410 in the fin and/or base 8 of the inner frame to be fixed rigidly relatively to the inner frame 3. The shank 403 extends through an aperture 411 in the inner wall 21 that in some forms, has at least one pair of parallel sides to mate with a shank 403 configured to have at least one pair of opposed parallel sides to preclude rotation of the shank in the assembled wing.

The threaded fastener 401 extends through an outer aperture 412 within the outer wall 20, this being configured as an oval shape to enable the outer frame members 17 to displace relative to the infill over their range of relative dispositions. The outer aperture 412 is surrounded by an oval recess 413 having a depth and width sufficient to receive the head 414 of the fastener 401 so that it does not protrude from the general form of the wing.

Adjacent to the internal wall 315 of the oval recess 413, the fastener 401 supports a substantially cylindrical bearing member 416 (such as a flat washer) having an internal aperture through which the fastener extends and/or a fixing member 417 (such as a crescent circlip) having an internal aperture through which the fastener extend; the fixing member 417 restricting relative displacement between the fastener 401 and outer frame member 17; the fixing member 417 being supported within a peripheral groove 418. In usage, the fastener 401 and shank 403 act as a telescopic joint where rotating the fastener in one direction cases the head 414 to displace the associated outer frame member 17 towards the inner frame 3 and rotating the fastener in the opposite direction causes the bearing member 416 to displace the associated outer frame member 17 away from the inner frame 3.

To facilitate assembly of the wing, an outwardly disposed end 420 of the shank 403 includes an additional coaxial cylindrical recess 421 having a circular floor 422. The recess 421 is configured to receive the bearing member 416 and the fixing member 417 and to have a depth that is substantially the same as the sum of their thicknesses—before assembly of the wing, they are retained within the recess 421 by inwardly extending side wall portions 423 that are formed by deforming the end as shown in FIG. 53. The fastener is configured to have an elongated unthreaded portion 424 extending from the underside of the head 414 connected by a conical portion 425 to a threaded portion 426 of lesser external diameter. The unthreaded portion 424 includes the peripheral groove 418 disposed to have an inner edge coplanar with the floor 422 when the outer frame member abuts the floor of the channel 15. The components are further configured so that the bearing member 416 and the fixing member 417 are free to slide longitudinally along the fastener and the bearing member 416 is free to slide longitudinally along the unthreaded portion 424 while the internal aperture of the fixing member 417 is required to increase in diameter (by elastically deforming) to slide over the unthreaded portion 424.

During assembly, each O1 connector is assembled by passing a fastener 401 through the aperture 412 to pass through, the bearing member 416 and the fixing member 417 to engage in the threaded portion of the shank. The O1 joint is further configured such that (when the wing is of minimum extent) rotation of the fastener 403 draws the conical portion 425 through the fixing member to cause it to expand to a diameter that enables it to slide along the unthreaded portion 424; further turning of the fastener brings the groove 427 into alignment with the fixing member 417 to enable the fixing member 417 to elastically deform inwardly to occupy the groove 427. By this means, the wall of the outer aperture 412 is captured between the bearing member 416 washer and head 414 of the screw to prevent relative longitudinal displacement between the screw and associated outer frame member 17.

### Type-2 Orthogonal Joint

In another forms, the orthogonal joint is configured as a Type-2 orthogonal joint 430 [“O2 joint”] having a compressed compression springs that acts to urge the infill towards the centre of area of the outer frame. The compressed compression spring 431 is supported about a substantially cylindrical joint boss 432 that is supported in the outer edge 22 of the outer frame member 17 to extend towards the inner edge 21 where it is disposed coaxially relative to an aperture 434; the aperture 434 being configured to enable the compression spring 431 to extend through the aperture 434 (while being supported about the joint boss 432) to abut the inner frame 3 to act on the inner frame. The joint boss includes an axially elongated threaded through aperture 435 that supports a threaded fastener 436 (such as a grub screw) that is accessible through a coaxial aperture 437 in the outer frame member to enable a tool (such as an Alan key) to be inserted into the fastener drive recess 440 to rotate the fastener and in some situations, to cause it to protrude from the joint boss 432 to act on the inner frame member 13 to displace the outer frame member 17 away from the inner frame 3. In some forms the joint boss 432 includes a substantially cylindrical end 439 of reduced diameter that extends through an aperture 437 in the outer frame member to be outwardly peened over (to form a ridge 442 that overlaps the outer frame member) to retain it attached to the outer frame member. In some forms, this aperture 441 is surrounded by a saucer shaped recess 443 having a depth sufficient to receive a house the ridge 442. This joint further includes a spring retaining disc 445 having a coaxial aperture 446 through which a substantially cylindrical end 447 of the fastener extends; in some forms, this disc 445 is surrounded by a saucer shaped recess 448 (in the inner edge) having a depth sufficient to accommodate the disc.

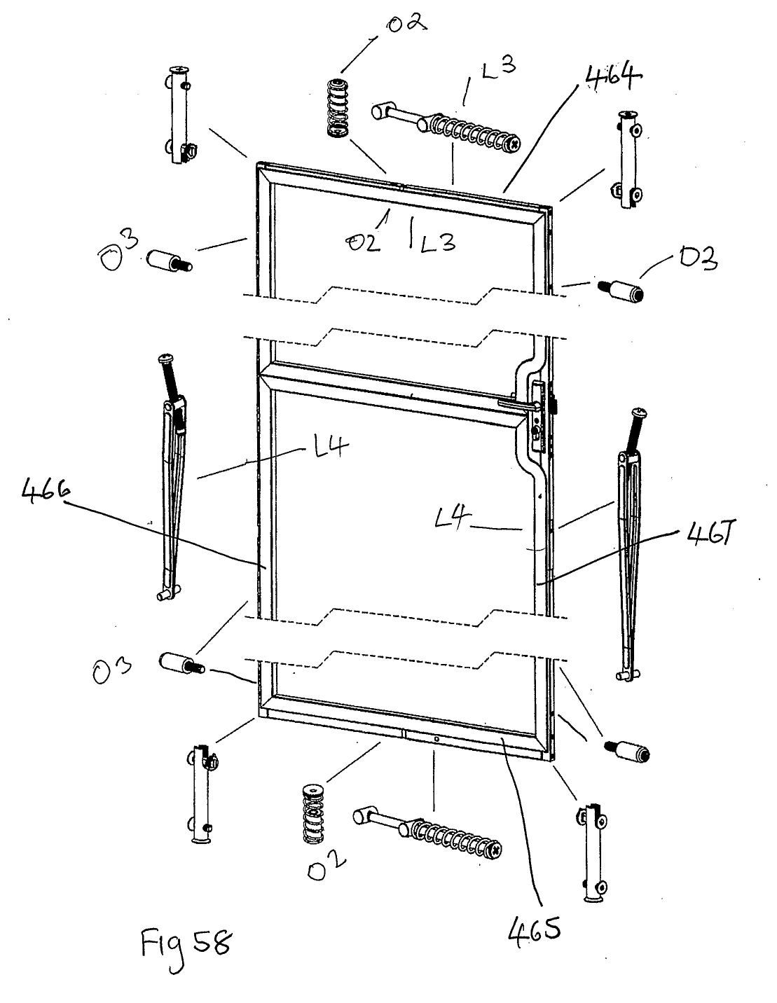

The O2 joint is further configured to have a pre-fitting configuration, as shown in FIG. 54, in which the compression spring is retained compressed between the disc 445 and outer edge 22 and where the end 443 extends through the aperture 446 to retain the disc 445 attached to the end 447 which is outwardly peened over to overlap the periphery of the aperture 446 in the disc while in some forms the end 447 includes opposed outwardly extending wings 449 that overlap the periphery of the aperture 446 in the disc which includes opposed outwardly extending extensions 450 through which the wings 449 have passage to enable the disc to be a) assembled to and b) be freed from the fastener 436.

During fitting, the outer frame members would be assembled to the infill to the smallest configuration with O2 joints in the pre-fitting configuration, and then each fasteners 436 is outwardly displaced to either a) force the peened end through the aperture by causing the peened ends to be inwardly deformed or b) align the extensions 450 with the wings 449 to release the disc 445 to release the spring 431 to enable it to exert and inwards force on the infill.

### Type-3 Orthogonal Joint

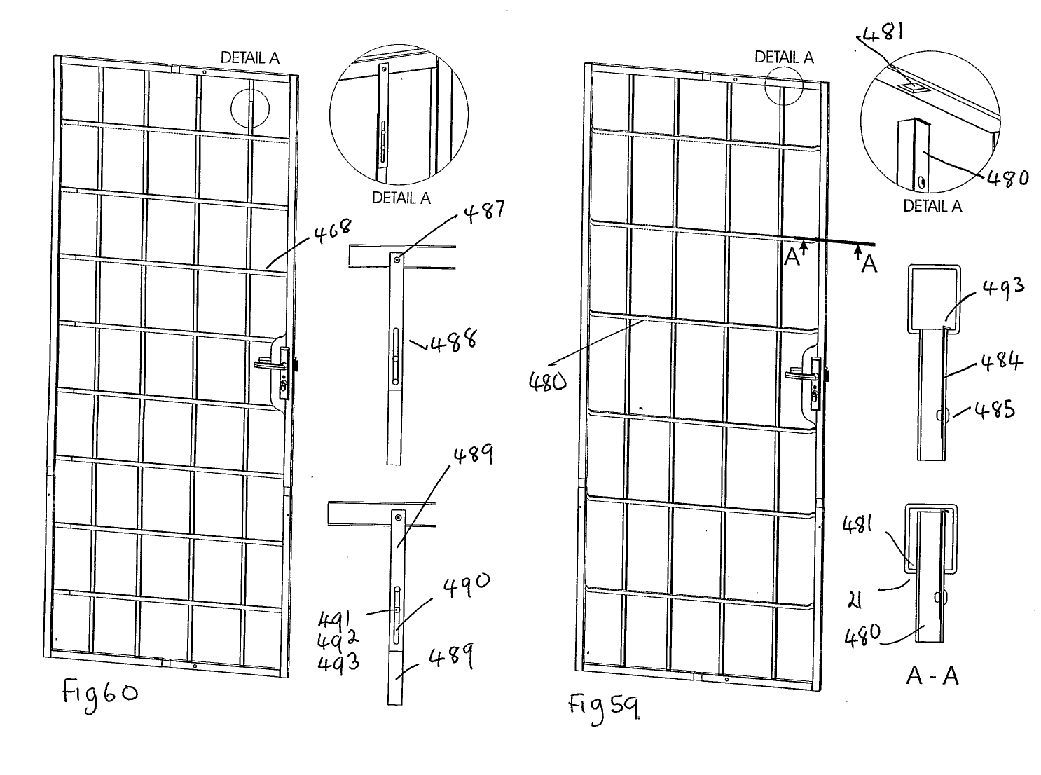

Type-2 orthogonal joints may be further configured to omit the springs to comprise Type-3 orthogonal joint [“O3”] as shown in FIGS. 56 and 57.

### Particular Wings Employing the Integers Described Above

Notwithstanding any other forms of wings employing combinations of the integers described above that may fall within the scope of the invention, some preferred forms of the inventions will now be described by way of example only with reference to the accompanying drawings. They will be described in particular, with reference to the manner in which they can be adapted to suit a particular opening.

Consider a substantially planar wing (FIG. 58) having a rectangular infill that is vertically disposed; it having an upper outer frame member 464, a lower outer frame member 465, a left hand side outer frame member 46 and an opposed right hand side outer frame member 467 each connected at each end to another outer frame member by a mortise or butt joint and each comprising a first outer frame portion 278 and a second outer frame portion 279 connected by a linear joint, the wing being adjustable from a configuration in which it is of smallest extent to a larger wing by increasing the length of one or more outer frame members 17 and by reconfiguring the included angles.

It will be appreciated that prior to adjustment, wings must be assembled by: configuring the infill 2 as a single substantially planar member if it consists of sub-infills; assembling the required first and second portions to provide the left hand and right hand outer frame members 466 an 467 if they have been configured in KD form that are then assembling them into the side channels of the infill, assembling the upper and lower outer frame members 464 and 465 to the infill by assembling the corner joints, (and if enhanced TB butt joints, by inserting and loosely tightening corner joiners; if adapted butt joints, by driving in wedges 250) and winding out the fasteners 436 in any O2 joints to release the springs 431. When the wing has been adjusted (including skewed as required) the corner are then made rigid as described above by operating fasteners. Particular forms of wing many be configured to have a larger extent as described below:

A) A Wing Having L1 Joints

Consider a wing where the left hand outer frame member 466 is lower than the right hand outer frame member 477, the springs acting on the fingers 272 of the sides will attempt to dispose the infill 2 such that its upper and lower inner frame members are parallel with the upper and lower outer frame members 466 and 467 but the springs acting in the upper and lower 466 and 467 will attempt to retain the infill such that the upper and lower inner frame members remain orthogonal to the left and right hand side outer frame member 466 and 467. The resulting configuration will be partway between these two configurations characterized by the competing spring forces together being in equilibrium. Where both the inner frame 3 and the outer frame 20 are rectangular, the springs act on the fingers to urge the centre of area of the inner frame towards the centre of area of the outer frame (this coinciding with the point of intersection of the diagonals) and the sides of the infill remain parallel the sides of the outer frame.

B) A Wing Having L2 Joints in Each Outer Frame Member and O1 Joints Adjacent to Each End.

This wing is adjusted in extent by:

1) Inserting a tool into the O1 joint in the right hand end of the hand upper outer frame member 464 and turning the tool till the upper end of the right hand side outer frame member 467 has been displaced away from the inner frame 3 by an amount of half the total increase in length required in outer frame member 467; inserting a tool into the O1 joint in the right hand end of the hand lower outer frame member 465 and turning the tool till the lower end of the right hand side outer frame member 467 has been displaced away from the inner frame 3 by an amount of half the total increase in length required in outer frame member 467

2) Inserting a tool into the O1 joint in the left hand end of the hand upper outer frame member 464 and turning the tool till the upper end of the left hand side outer frame member 466 has been displaced away from the inner frame 3 by an amount of half the total increase in length required in outer frame member 466; inserting a tool into the O1 joint in the left hand end of the hand lower outer frame member 465 and turning the tool till the lower end of the left hand side outer frame member 466 has been displaced away from the inner frame 3 by an amount of half the total increase in length required in outer frame member 467

3) Increasing the length of the upper and rower outer frame member 464 by in a similar manner by the turning fasteners in the other O1 joints

4) Skewing the wing to suit a particular opening and tightening the fasteners in all the corners to render the corners rigid.

C) A Wing Having L4 Joints in Each Outer Frame Member and O2 Joints Adjacent to Each End of Each Outer Frame Member.

In this wing, a particular outer frame member may be adjusted in length by operating the fastener within the L4 joint within that particular outer frame member and where the outer frame may be skewed as required after which, the corner fasteners would be tightened to render the corners rigid. This may be better understood by considering the skewing of a wing where the skewing is artificially controlled so that the outer frame is skewed while the infill is held undisplaced and then the infill is released to find an equilibrium configuration.

When the left hand side outer frame member 466 is displaced to be lower than the right hand outer side member 467, the spring acting at the left hand end of the upper frame member 464 is further compressed by the action of skewing to exert an increased force on the left hand side of the infill urging it downwardly while the spring acting on the bottom of the right hand side of the infill will also be further compressed to exert an increased force on the right hand side of the infill upwardly and the spring acting on the right hand end of the upper frame member 467 becomes further extended by the action of skewing to exert a reduced force on the right hand side of the infill while the spring acting on the bottom of the left hand side of the infill will also be further extended to exert a reduced force on the right hand side of the infill. The net result is a torque that acts on the infill to urge it to rotate as urged. The forces derived from the springs acting on the sides of the infill however act in a similar manner so that any rotation of the infill gives rise to a reactionary torque that acts to urge the infill against rotation. The resulting configuration is characterized by the competing torques being equal and the spring forces being in equilibrium. Where the wing of increased extent is also rectangular, the springs act to urge the centre of area of the inner frame towards the centre of area of the outer frame, this coinciding with the point of intersection of the diagonals. In application this wing would be adjusted by:

1) Releasing the compression springs in the orthogonal joints

2) Increasing the length of the right hand outer frame member 467

3) Increasing the length of the left hand outer frame member

4) Increasing the length of the upper and lower outer frame member in a similar manner,

5) Skewing the wing as required and tightening the fasteners in the corners to render the corners rigid.

6) If desired, winding the O2 joint fasteners 436 inwardly till they abut either the inner frame or disc to render the wing more rigid.

D) A Wing (as Shown in FIG. 58) Having: in the Middle of the Upper and Lower Outer Frame Members a L3 and a O2 Joint; in the Left Hand and Right Hand Outer Frame Members, a L4 Joint and O3 Joints Towards the Upper and Lower Ends of these Side Members.

In this wing, the upper outer frame member 464 may be increased in length (against biasing provided by a L3 joints) by operating the fasteners 436 in the upper O3 joints [in the left hand and right hand side outer frame members 466 and 467]; and where lower outer frame member 465 may be increased in length by operating the fasteners in the lower O3 joints [in the left hand and right hand side outer frame members 466 and 467]: and where the left hand outer frame member 466 and right hand side outer frame member 467 many be increased in length by operating the fasteners within the L4 joints within their lengths while the springs within the O2 joints in the upper and lower outer frame members 464 and 465 adjust to exert an adjusted force on the infill; after which the wing would be skewed as required.

The resulting final configuration would be characterized by the competing torques being equal and the spring forces being in equilibrium. If desired, winding the O2 joint fasteners (in the upper and lower frame member) inwardly till they abut either the inner frame or disc to render the wing more rigid. Wings as described in D) above are particularly well disposed for inclusion in oblong wings where the O3 joints are within the shorter of the opposed outer frame members and in the particular forms referenced, in the upper and lower outer frame members which are shorter than the opposed side outer frame members.

Some doors, windows, grills and screens include one of the forms of wings described immediately above; in the case of hinged doors, the wing would be further configured to include a lock in the closing edge outer frame member and hinges would be attached to the opposed outer frame member to enable the wing to be suspended adjacent to an opening.

If we consider a door configured in the (D) format described above and further configured in KD format the door would be assembled by.
Configuring the infill as a single substantially planar member,
Assembling first and second portions to provide the left hand and right hand outer frame members
Assembling the outer frame members around the infill into the side channels
Driving in the corner wedges or loosely tightening corner fasteners
Winding out the screws in the O2 joints in the upper and lower outer frame members to release the springs

The hinged door would be fitted to the opening by:

1) Lengthening the left and right hand side outer frame members by operating the fasteners in the L4 joints within this member.

2) Suspending the wing by the hinges

3) Lengthening the upper frame member 464 by a) rotating the fastener in the upper right hand side O3 joint till the upper outer frame member has lengthened by half the desired amount b) rotating the fastener in the upper left hand side O3 joint till the upper outer frame member has lengthened by half the desired amount

4) Similarly, lengthening the lower outer frame member 467

5) Skewing the wing to suit a particular opening and tightening the corner fasteners by tool

6) Tightening the fasteners in the O2 joints.

One of the features of this form is having access to all the fasteners when the door is suspended because the access apertures are located in the left hand and right edges of the wing (i.e. in the outer edges 22 of the left and right hand outer frame member

### Additional Fasteners

Once the wing has been adjusted and if additional rigidity is required, additional fasteners 470 (such as rivets or mushroom head screws) may be applied to simultaneously intersect both an inner frame member 13 and an outer frame member 17 and/or to intersect corner connectors and outer and/or inner frame members by extending through apertures in each and they could be inserted to extend between the U shaped member and outer frame portions.

In rather obvious reductions of the inventions described within (and embraced by the inventions).

a) The outer frame members could be cut to the required length at fitting (to suit a particular opening) to be mounted around an infill of predetermined dimensions and where in some forms, to be connected to each other by mortise corner joints similar to those described within. Although an inferior method, this method still provides an advantage over conventional methods of “making to measure” complete doors to suit particular openings.

b) the infill may be attached relative to an outer frame as described above but only by spaced members that inter-connect the outer frame and infill to suspend the infill. The connectors, infill and outer frame members could also be further connected by the additional fasteners.

1-62. (canceled)

63. A structure including an infill resistant to deformation and an outer frame that extends within a peripheral recess of the infill to overlap the infill, said outer frame being reconfigurable to change the shape of the structure.

64. A structure according to claim 63, wherein the outer frame includes at least one outer frame member comprising a pair of outer frame portions connected by a telescopic joint.

65. A structure according to claim 64, wherein the outer frame extends continuously around substantially the entire periphery of the structure within the peripheral recess.

66. A structure according to claim 65, wherein the peripheral recess takes the forms of a peripheral channel.

67. A structure according to claim 66, wherein the infill comprises infilling material attached to and bounded in-part by an inner frame having the outwardly disposed peripheral channel.

68. A structure according to claim 67, wherein each outer frame member is connected at each end to another outer frame member by a corner joint.

69. A structure according to claim 68, wherein the corner joint is defined in part by an included angle that defines the angle between the longitudinal axii of the outer frame members participating in the corner joint, said corner joint being electively reconfigurable to change the included angle.

70. A structure according to claim 69, configured as a substantially planar wing including an outer frame comprising two pair of opposed outer frame members, each said outer frame member including a pair of associated outer frame portions connected by a linear joint, each said outer frame member being connected to each outer frame member of the other pair by a corner joint defined in part by an included angle that may be changed.

71. A structure according to claim 70, wherein the outer frame portions have identical and substantially rectangular cross-sections.

72. A structure according to claim 69, wherein, wherein each corner joint comprises an adaptable butt joint.

73. A structure according to claim 72, wherein the adaptable butt joint includes a bearing shoulder that projects from the end of an outer frame member to mate within a bearing recess formed within the inside edge of a respecting connected outer frame member.

74. A structure according to claim 70, wherein the infill includes multiple sub-infills of reduced height.

75. A structure according to claim 70, including means to displace the infill to a pre-determined configuration relative to the outer frame.

76. A structure according to claim 69, including means to displace the infill such that the centre of area of the infill coincides with the centre of area of the outer frame.

77. A structure including an infill and a peripheral frame said infill being adaptable in response to re-configuration of the outer frame.

78. A structure according to claim 77, wherein the infill comprises discrete strip members each consisting of strip portions connected by a telescopic joint.

79. A structure according to claim 77, wherein the infill remains connected to the peripheral frame within the pre-determined configurations the peripheral frame can assume.

80. A structure according to any one of claim 78, wherein the infill comprises discreet bars each having each end projecting into a recess of the peripheral frame.

81. A structure according to claim 77, wherein the outer frame includes at least one outer frame member comprising a pair of outer frame portions connected by a telescopic joint.

82. A structure according to claim 70, configured as an angularly displaceable door and having a lock attached to a closing edge.

83. A structure according to claim 77, configured as an angularly displaceable door and having a lock attached to a closing edge.

84. A structure according to claim 82, including outer frame members connected at each end to another outer frame member by a corner joint each defined in part by an included angle that defines the angle between the respective longitudinal axii of the outer frame members participating in the corner joint, said corner joint being electively reconfigurable to change the included angle.

85. A structure according to claim 83, including outer frame members connected at each end to another outer frame member by a corner joint each defined in part by an included angle that defines the angle between the respective longitudinal axii of the outer frame members participating in the corner joint, said corner joint being electively reconfigurable to change the included angle.

86. A structure according to claim 70, configured as a substantially conventional Australian angularly displaceable screen door having a substantially conventional Australian security door lock having a lock body supported within an outer frame member.

87. A structure according to claim 84, configured as a substantially conventional Australian angularly displaceable screen door having a substantially conventional Australian security door lock having a lock body supported within an outer frame member.

88. A structure according to claim 85, configured as a substantially conventional Australian angularly displaceable screen door having a substantially conventional Australian security door lock having a lock body supported within an outer frame member.

89. A structure according to claim 67, wherein the infill consists of an infill for a screen door that includes infilling material having a peripheral return portion that projects sideways to occupy a side recess of an inner frame.

90. A structure according to claim 89, wherein the peripheral return portion extends along substantially the entire peripheral edge of the infilling material.

91. A structure comprising a substantially planar door including an infill and an outer frame reconfigurable to change the shape of the door, said infill being resistant to deformation and comprising infilling material attached to and bounded in-part by an inner frame having an outwardly disposed peripheral channel, said outer frame extending continuously around substantially the entire periphery of the door and within the peripheral channel, said outer frame including multiple discrete outer frame members at least one of which comprises a pair of outer frame portions connected by a telescopic joint and wherein each outer frame member is connected at each end to another outer frame member by a corner joint each defined in part by an included angle that defines the angle between the respective longitudinal axii of the outer frame members participating in the said corner joint, said corner joint being electively reconfigurable to change the included angle.

92. A structure according to claim 91, including a lock having a lock body supported within the outer frame member.

93. A structure according to claim 69, wherein each corner joint includes an operable member that may be operated to render the respective corner joint rigid.

94. A structure according to claim 84, wherein each corner joint includes an operable member that may be operated to render the respective corner joint rigid.

95. A structure according to claim 85, wherein each corner joint includes an operable member that may be operated to render the respective corner joint rigid.

96. A structure according to claim 64, wherein the telescopic joint includes an operable member that may be operated to change the length of the respective outer frame member.

97. A structure according to claim 76, wherein the means to displace the infill includes an operable member that may be operated to change the length of the respective outer frame member.
